(19) United States
(12) Patent Application Publication
(10) Pub. No.: US 2011/0205205 A1
(43) Pub. Date: Aug. 25, 2011

(54) Pixel circuit, display device, method of driving the display device, and electronic unit

(75) Inventors: Tetsuro Yamamoto, Kanagawa (JP); Katsuhide Uchino, Kanagawa (JP)

(73) Assignee: Sony Corporation, Tokyo (JP)

(21) Appl. No.: 12/929,001

(22) Filed: Dec. 22, 2010

(30) Foreign Application Priority Data
Feb. 24, 2010 (JP) 2010-039270

(51) Int. Cl. G06F 3/038

(52) U.S. Cl. 345/211

(57) ABSTRACT

A display device includes: a pixel circuit including a light emitting element, first to third ,transistors, and a capacitive element; and a scan line. The pixel circuit is configured in such a manner that, one of a drain and a source of the first transistor is connected to a gate of the second transistor, the third transistor and the capacitive element are connected in series between a gate of the first transistor and the gate of the second transistor, and variation in scan line voltage is transmitted to the gate of the second transistor via the third transistor and the second capacitive element.

### BACKGROUND OF THE INVENTION

1. Field of the Invention

The present invention relates to a pixel circuit including a light emitting element, a display device performing image display using such a pixel circuit, a method of driving the display device, and an electronic unit having such a display device.

2. Description of Related Art

Recently, in a field of display devices for image display, a display device using current-drive optical elements as light emitting elements, each optical element being changed in luminance in accordance with a value of electric current flowing through the optical element, for example, a display device using organic EL (Electro Luminescence) elements (organic EL display device) has been developed and is being commercialized.

The organic EL element is a self-luminous element unlike a liquid crystal element or the like. Therefore, the organic EL display device does not need a light source (backlight), and therefore the display device is high in image visibility, low in power consumption, and high in response speed of an element compared with a liquid crystal display device that needs a light source.

A drive method of the organic EL display device includes simple (passive) matrix drive and active matrix drive as in the liquid crystal display device. The simple matrix drive may simplify a device structure, but disadvantageously hardly provides a large display device with high definition. Therefore, the active matrix drive is being actively developed at present. In the active matrix drive, electric current flowing through an organic EL element disposed for each pixel is controlled by an active element (typically, TFT (Thin Film Transistor)) in a driver circuit provided for each organic EL element.

It is generally known that a current-to-voltage (I-V) characteristic of an organic EL element is degraded with the lapse of time (temporal degradation). In a pixel circuit driving an organic EL element by electric current, when the I-V characteristic of an organic EL element is temporally changed, a value of current flowing through a driver transistor is changed, and therefore a value of current flowing through the organic EL element itself is also changed, and luminance is correspondingly changed.

Threshold voltage Vth or mobility μ of a driver transistor may be temporally changed, or may be different for each of pixel circuits due to variation in a manufacturing process. When threshold voltage Vth or mobility μ of the driver transistor is different for each of pixel circuits, a value of current flowing through the driver transistor also varies for each of the pixel circuits. Therefore, even if the same voltage is applied to gates of respective driver transistors, luminance of the organic EL element varies, leading to reduction in uniformity of a screen image.

Thus, it has been proposed that even if the I-V characteristic of an organic EL element temporally changes, or threshold voltage Vth or mobility μ of a driver transistor temporally changes or varies for each of pixel circuits, luminance of an organic EL element is kept constant without being affected by such change or the like. Specifically, a display device has been proposed, which has a function of compensating variation in I-V characteristic of an organic EL element and a function of correcting variation in threshold voltage Vth or mobility μ of a driver transistor (for example, see Japanese Unexamined Patent Application Publication No. 2008-33193).

### SUMMARY OF THE INVENTION

In the correction operation of threshold voltage Vth (Vth correction operation) proposed in Japanese Unexamined Patent Application Publication No. 2008-33193, such Vth correction operation is performed several times in a segmented manner (segmented Vth correction operation). In this case, when Vth correction operation has not been completed (finished), gate-to-source voltage Vgs of a driver transistor is higher than threshold voltage Vth of the transistor (Vgs>Vth). Therefore, when each segmented Vth correction period is short, or a period (Vth correction suspension period) between the respective segmented Vth correction periods is long, source potential of the driver transistor may excessively increases in the Vth correction suspension period.

After that, when the segmented Vth correction operation is performed again, the gate-to-source voltage Vgs of the driver transistor is smaller than the threshold voltage Vth (Vgs<Vth), and therefore Vth correction operation is not normally performed thereafter. As a result, Vth correction operation is finished before the being completed, namely, is insufficiently performed, and consequently variation in luminance remains between pixels. Particularly, when high-speed display drive is performed, since length of one horizontal period (1 H period) is reduced, time of Vth correction is correspondingly reduced, and therefore such a difficulty particularly occurs.

Thus, for example, Japanese Patent No. 4306753 proposes a method as a measure to overcome such a difficulty. Specifically, first, voltage applied to a signal line is set to a potential being lower than a predetermined base voltage at the end of each segmented Vth correction operation. This leads to lowering of gate potential of a driver transistor from the base voltage to the relevant low potential, and therefore gate-to-source voltage Vgs of the driver transistor becomes lower than threshold voltage Vth of the transistor (Vgs<Vth) in a subsequent Vth correction suspension period. In a subsequent segmented Vth correction period, gate potential of the driver transistor is newly set to the base voltage so that normal Vth correction operation is performed again. According to the method, the difficulty of excessive increase in source potential of the driver transistor may be avoided in the Vth correction suspension period.

However, the method of Japanese Patent No. 4306753 needs three-valued voltage to be applied to the signal line (uses three-valued voltage including video signal voltage, the base voltage and the low potential as signal voltage), leading to increase in withstanding voltage of a driver circuit (particularly, signal line driver circuit) compared with in the past. Generally, when withstanding voltage of a driver circuit (driver) increases, manufacturing cost accordingly increases, and therefore the method has been necessary to be improved in the light of reduction in cost.

Such a difficulty described hereinbefore may occur not only in the organic EL display device, but also in other display devices using self-luminous elements.

It is desirable to provide a pixel circuit that may provide reduction in cost together with high image quality, a display device using the pixel circuit, a method of driving the display device, and an electronic unit using the display device.

A pixel circuit according to an embodiment of the invention includes a light emitting element, first to third transistors, a first capacitive element as holding capacitive element, and a second capacitive element. A gate of the first transistor is connected to a first scan line applied with a selection pulse including a predetermined on-voltage and a predetermined off-voltage. One of a drain and a source of the first transistor is connected to a signal line, being alternately applied with a predetermined base voltage and a predetermined video signal voltage, and the other is connected to a gate of the second transistor and to one end of the first capacitive element. One of a drain and a source of the second transistor is connected to a power line, being applied with a power control pulse to perform emission on/off control on the light emitting element, and the other is connected to the other end of the first capacitive element and to an anode of the light emitting element. A cathode of the light emitting element is set to a fixed potential. The third transistor and the second capacitive element are connected in series between the gate of the first transistor and the gate of the second transistor, and a gate of the third transistor is connected to a second scan line applied with a switching control pulse to perform on/off control on the third transistor.

A display device according to an embodiment of the invention includes a plurality of pixels, each pixel having a pixel circuit including a light emitting element, first to third transistors, a first capacitive element as holding capacitive element, and a second capacitive element; first and second scan lines, a signal line and a power line, the lines being connected to each pixel; a scan line driver circuit applying a selection pulse to the first scan line, the selection pulse including a portion of predetermined on-voltage and a portion of predetermined off-voltage to select a group of pixels from the plurality of pixels one after another, the scan line driver circuit further applying a switching control pulse to the second scan line to perform on/off control on the third transistor; a signal line driver circuit alternately applying a predetermined base voltage and a predetermined video signal voltage to the signal line to write the video signal to a corresponding pixel in the group of pixels selected by the scan line driver circuit; and a power line driver circuit applying a power control pulse to the power line to perform emission on/off control on the light emitting element. In the pixel circuit, a gate of the first transistor is connected to the first scan line. One of a drain and a source of the first transistor is connected to the signal line, and the other is connected to a gate of the second transistor as well as one end of the first capacitive element. One of a drain and a source of the second transistor is connected to the power line, and the other is connected to the other end of the first capacitive element as well as an anode of the light emitting element. A cathode of the light emitting element is set to a fixed potential. The third transistor and the second capacitive element are connected in series between the gate of the first transistor and the gate of the second transistor, and a gate of the third transistor is connected to the second scan line.

An electronic unit according to an embodiment of the invention includes the display device of the embodiment of the invention.

In the pixel circuit, the display device and the electronic unit according to the embodiments of the invention, the pixel circuit has the above circuit configuration, which may provide, for example, a gate potential correction operation during an on-period in which the third transistor is activated by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor. According to such operation, gate potential correction operation to lower gate potential of the second transistor may be performed. Therefore, gate-to-source voltage (Vgs) of the second transistor may be reduced, and, for example, when at least one threshold correction operation is performed to the second transistor, insufficient threshold correction operation due to excessive increase in source potential of the second transistor may be avoided, namely, sufficient (normal) threshold correction operation may be performed. In addition, such gate potential correction operation is achieved by using a variation in first scan line voltage from the on-voltage to the off-voltage, or a variation between two voltages, and therefore three-valued voltage need not be used unlike in the past (for example, three-valued voltage need not be applied to the signal line).

A method of driving a display device according to an embodiment of the invention includes steps of: connecting a plurality of pixels to first and second scan lines, a signal line and a power line, the plurality of pixels each having a pixel circuit including a light emitting element, first to third transistors, a first capacitive element as holding capacitive element and a second capacitive element; applying a selection pulse to the first scan line, the selection pulse including a portion of predetermined on-voltage and a portion of predetermined off-voltage to select a group of pixels from the plurality of pixels one after another, while alternately applying a predetermined base voltage and a predetermined video signal voltage to the signal line to write a video signal to a corresponding pixel in the group of pixels selected; and applying a power control pulse to the power line to perform emission on/off control on the light emitting element. A gate potential correction operation is performed during an on-period in which the third transistor is set to be on by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor.

In the method of driving a display device according to the embodiment of the invention, a gate potential correction operation is performed during an on-period in which the third transistor is activated by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor. Therefore, gate-to-source voltage (Vgs) of the second transistor is reduced, and, for example, when at least one threshold correction operation is performed to the second transistor, insufficient threshold correction operation due to excessive increase in source potential of the second transistor is avoided, namely, sufficient (normal) threshold correction operation is performed. In addition, such gate potential correction operation is achieved by using a variation in first scan line voltage from the on-voltage to the off-voltage, or a variation between two voltages, and therefore three-valued voltage need not be used unlike in the past (for example, three-valued voltage need not be applied to the signal line).

According to the pixel circuit, the display device, the method of driving the display device, and the electronic unit of the embodiments of the invention, the gate potential correction operation to lower gate potential of the second transistor is performed, thereby insufficient threshold correction operation due to excessive increase in source potential of the second transistor may be avoided without using three-valued voltage unlike in the past. Consequently, variation in luminance between pixels may be suppressed without increasing withstanding voltage of a driver circuit, and consequently reduction in cost and improvement in image quality may be achieved together.

Other and further objects, features and advantages of the invention will appear more fully from the following description.

### BRIEF DESCRIPTION OF THE DRAWINGS

FIG. 1 is a block diagram showing an example of a display device according to a first embodiment of the invention.

FIG. 2 is a circuit diagram showing an example of an internal configuration of each pixel shown in FIG. 1.

FIG. 3 is a timing waveform chart showing an example of operation of the display device according to the first embodiment.

FIG. 4 is a circuit diagram showing an example of an operation state in operation of the display device shown in FIG. 3.

FIG. 5 is a circuit diagram showing an example of an operation state following FIG. 4.

FIG. 6 is a circuit diagram showing an example of an operation state following FIG. 5.

FIG. 7 is a characteristic diagram for illustrating temporal degradation of an I-V characteristic of a display device.

FIG. 8 is a circuit diagram showing an example of an operation state following FIG. 6.

FIG. 9 is a characteristic diagram showing an example of temporal change of source potential of a driver transistor.

FIG. 10 is a circuit diagram showing an example of an operation state following FIG. 8.

FIG. 11 is a circuit diagram showing an example of an operation state following FIG. 10.

FIG. 12 is a circuit diagram showing an example of an operation state following FIG. 11.

FIG. 13 is a characteristic diagram showing an example of a relationship between temporal change of source potential of a driver transistor and mobility of the transistor.

FIG. 14 is a circuit diagram showing an example of an operation state following FIG. 12.

FIG. 15 is a circuit diagram showing an internal configuration of each pixel in a display device according to each of comparative examples 1 to 4.

FIG. 16 is a timing waveform chart showing operation of a display device according to comparative example 1.

FIG. 17 is a timing waveform chart showing operation of a display device according to comparative example 2.

FIG. 18 is a timing waveform chart showing an example of operation of a display device according to a second embodiment.

FIG. 19 is a circuit diagram showing an example of an operation state in operation of the display device as shown in FIG. 18.

FIG. 20 is a circuit diagram showing an example of an operation state following FIG. 19.

FIG. 21 is a circuit diagram showing an example of an operation state following FIG. 20.

FIG. 22 is a circuit diagram showing an example of an operation state following FIG. 21.

FIG. 23 is a circuit diagram showing an example of an operation state following FIG. 22.

FIG. 24 is a timing waveform chart showing operation of a display device according to comparative example 3.

FIG. 25 is a schematic diagram showing an example of a display image of the display device according to the comparative example 3 when one common line is used in place of several power lines.

FIG. 26 is a timing waveform chart showing operation of a display device according to comparative example 4.

FIG. 27 is a timing waveform chart showing an example of operation of the display device of the second embodiment when one common line is used in place of several power lines.

FIG. 28 is a timing waveform chart showing an example of operation of a display device according to a third embodiment.

FIG. 29 is a plan diagram showing a schematic configuration of a module including the display device of each embodiment.

FIG. 30 is a perspective diagram showing appearance of application example 1 of the display device of each embodiment.

FIGS. 31A and 31B are perspective diagrams, where FIG. 31A shows appearance of application example 2 as viewed from a front side, and FIG. 31B shows appearance thereof as viewed from a back side.

FIG. 32 is a perspective diagram showing appearance of application example 3.

FIG. 33 is a perspective diagram showing appearance of application example 4.

FIGS. 34A to 34G are diagrams of application example 5, where FIG. 34A is a front diagram of the application example 5 in an opened state, FIG. 34B is a side diagram thereof, FIG. 34C is a front diagram thereof in a closed state, FIG. 34D is a left side diagram thereof, FIG. 34E is a right side diagram thereof, FIG. 34F is a top diagram thereof, and FIG. 34G is a bottom diagram thereof.

### DETAILED DESCRIPTION OF THE PREFERRED EMBODIMENTS

Hereinafter, preferred embodiments of the invention will be described in detail with reference to drawings. Description is made in the following sequence.

1. First embodiment (example of gate potential correction operation after start of Vth correction operation)

2. Second embodiment (example of gate potential correction operation before start of Vth correction operation)

3. Third embodiment (example of combination of first and second embodiments)

4. Module and application examples

5. Modifications

### First Embodiment

Configuration of Display Device

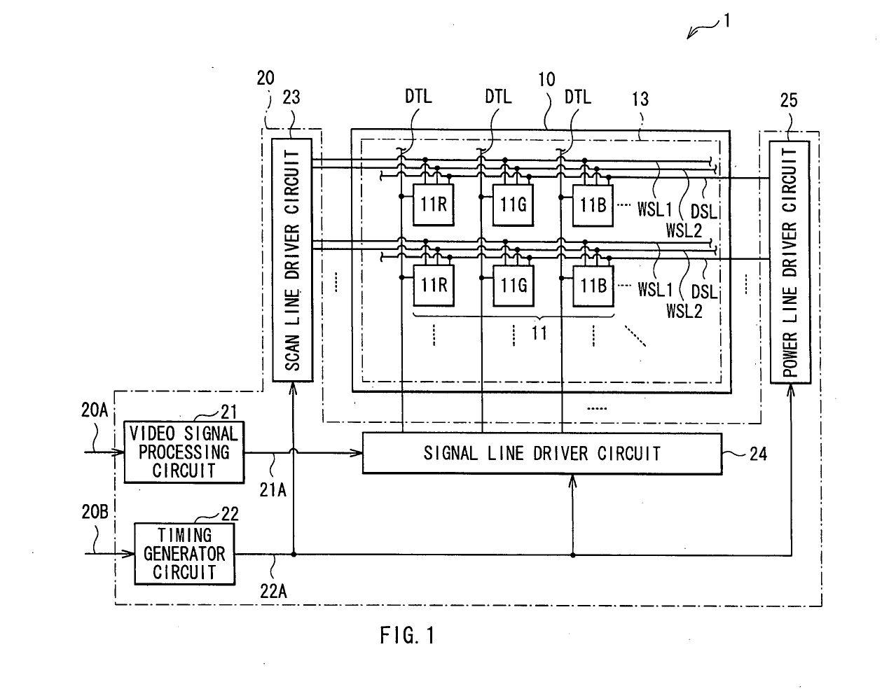

FIG. 1 shows a block diagram showing a schematic configuration of a display device (display device 1) according to a first embodiment of the invention. The display device 1 has a display panel 10 (display section) and a driver circuit 20.

Display Panel 10

The display panel 10 has a pixel array section 13 having a plurality of pixels 11 arranged in a matrix therein and thus performs image display by active matrix drive based on a video signal 20A and a synchronizing signal 20B received from the outside. Each pixel 11 is configured of a red pixel 11R, a green pixel 11G and a blue pixel 11B. Hereinafter, a term, pixel 11, is appropriately used as a general term of the pixels 11R, 11G and 11B.

The pixel array section 13 has a plurality of scan lines WSL1 (first scan lines) and a plurality of scan lines WSL2 (second scan lines), being arranged in rows respectively, a plurality of signal lines DTL arranged in columns, and a plurality of power lines DSL arranged in rows along the scan lines WSL1 and WSL2. The scan lines WSL1 and WSL2, the signal lines DTL and the power lines DSL are connected at respective one ends to the driver circuit 20 described later. The pixels 11R, 11G and 11B are arranged in a matrix (matrix arrangement) in correspondence to intersections between the scan lines, WSL1 and WSL2, and the signal lines DTL.

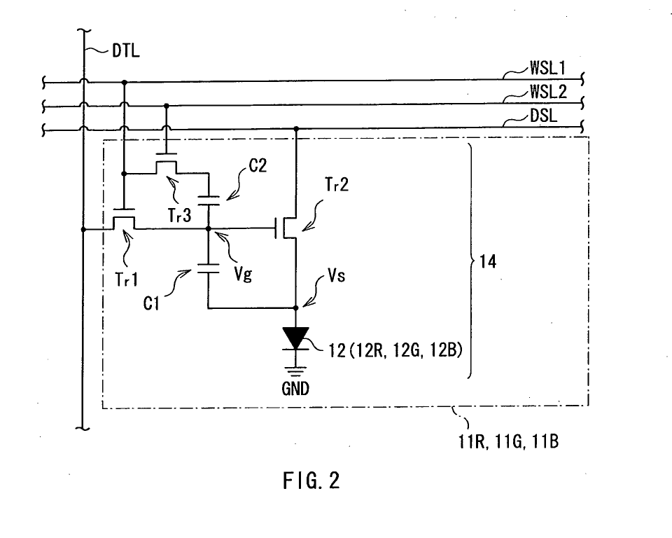

FIG. 2 shows an example of an internal configuration of a pixel 11R, 11G or 11B. A pixel circuit 14 including an organic EL element 12R, 12G or 12B (light emitting element) is provided in the pixel 11R, 11G or 11B. Hereinafter, a term, organic EL element 12, is appropriately used as a general term of the organic EL elements 12R, 12G and 12B.

The pixel circuit 14 includes the organic EL element 12, a write (sampling) transistor Tr1 (first transistor), a driver transistor Tr2 (second transistor), a threshold-correction auxiliary transistor Tr3 (third transistor), a holding capacitive element C1 (first capacitive element), and a threshold-correction auxiliary capacitive element C2 (second capacitive element). Among them, the threshold-correction auxiliary transistor Tr3 and the threshold-correction auxiliary capacitive element C2 perform predetermined auxiliary operation (gate potential correction auxiliary operation) respectively in threshold correction (Vth correction) described later. The write transistor Tr1, the driver transistor Tr2, and the threshold-correction auxiliary transistor Tr3 are formed of, for example, n-channel MOS (Metal Oxide Semiconductor) TFT. A type of TFT is not particularly limited, and, for example, may include an inversely staggered structure (so-called bottom gate type) or a staggered structure (so-called top gate type).

In the pixel circuit 14, a gate of the write transistor Tr1 is connected to the scan line WSL1, a drain of the transistor is connected to the signal line DTL, and a source thereof is connected to a gate of the driver transistor Tr2, to one end of the holding capacitive element C1, and to one end of the threshold-correction auxiliary capacitive element C2. A drain of the driver transistor Tr2 is connected to the power line DSL, and a source thereof is connected to the other end of the holding capacitive element C1 and to an anode of the organic EL element 12. A gate of the threshold-correction auxiliary transistor Tr3 is connected to the scan line WSL2, a drain of the transistor is connected to the scan line WSL1 and the gate of the write transistor Tr1, and a source thereof is connected to the other end of the threshold-correction auxiliary capacitive element C2. In other words, the threshold-correction auxiliary transistor Tr3 and the threshold-correction auxiliary capacitive element C2 are connected in series between the gate of the write transistor Tr1 and the gate of the driver transistor Tr2. A cathode of the organic EL element 12 is set to a fixed potential, which is here connected to a ground line GND to be set to ground (ground potential). The cathode of the organic EL element 12 serves as a common electrode of organic EL elements 12, and, for example, is continuously formed as a plate-like electrode over the whole display region of the display panel 10.

Driver Circuit 20

The driver circuit 20 drives the pixel array section 13 (display panel 10) (performs display drive). Specifically, as described in detail later, while sequentially selecting a plurality of pixels 11 (11R, 11G and 11B) in the pixel array section 13, the driver circuit 20 writes a video signal voltage based on the video signal 20A to a selected pixel 11, and thus performs display drive of the pixels 11. As shown in FIG. 1, the driver circuit 20 has a video signal processing circuit 21, a timing generator circuit 22, a scan line driver circuit 23, a signal line driver circuit 24, and a power line driver circuit 25.

The video signal processing circuit 21 performs predetermined correction on a digital video signal 20A received from the outside, and outputs a corrected video signal 21A to the signal line driver circuit 24. Such predetermined correction includes, for example, gamma correction and overdrive correction.

The timing generator circuit 22 generates a control signal 22A based on the synchronizing signal 20B received from the outside and outputs the control signal 22A so as to control the scan line driver circuit 23, the signal line driver circuit 24, and the power line driver circuit 25 to operate in conjunction with one another.

The scan line driver circuit 23 sequentially applies a selection pulse to a plurality of scan lines WSL1 in accordance with (in synchronization with) the control signal 22A so as to sequentially select a plurality of pixels 11 (11R, 11G and 11B). Specifically, the scan line driver circuit 23 selectively outputs voltage Von1 (on voltage), which is applied when the write transistor Tr1 is set to be on, and voltage Voff1 (off voltage), which is applied when the write transistor Tr1 is set to be off, and thus generates the selection pulses. The voltage Von1 has a value (certain value) equal to or larger than a value of on voltage of the write transistor Tr1, and the voltage Voff1 has a value (certain value) smaller than the value of the on voltage of the write transistor Tr1.

Moreover, as described later, the scan line driver circuit 23 sequentially applies a predetermined switching control pulse to a plurality of scan lines WSL2 in accordance with (in synchronization with) the control signal 22A so as to perform on/off control on the threshold-correction auxiliary transistor Tr3. Specifically, the scan line driver circuit 23 selectively outputs voltage Von2, which is applied when the threshold-correction auxiliary transistor Tr3 is set to be on, and voltage Voff2, which is applied when the transistor Tr3 is set to be off, and thus generates the switching control pulse. This leads to predetermined gate potential correction operation in Vth correction as described later. The voltage Von2 has a value (certain value) equal to or larger than a value of on voltage of the threshold-correction auxiliary transistor Tr3, and the voltage Voff2 has a value (certain value) smaller than the value of the on voltage of the transistor Tr3.

The signal line driver circuit 24 generates an analog video signal corresponding to the video signal 21A received from the video signal processing circuit 21 in accordance with (in synchronization with) the control signal 22A, and applies the analog video signal to each signal line DTL. Specifically, the signal line driver circuit 24 applies an analog video signal voltage based on the video signal 21A to each signal line DTL so that writing of a video signal is performed to a pixel 11 (11R, 11G and 11B) (as a selection object) selected by the scan line driver circuit 23. Writing of a video signal means that a predetermined voltage is applied between the gate and the source of the driver transistor Tr2.

The signal line driver circuit 24 may output two kinds of voltages, video signal voltage Vsig based on the video signal 20A and base voltage Vofs, and alternately applies the two kinds of voltages to each signal line DTL every one horizontal (1 H) period. The base voltage Vofs is applied to the gate of the driver transistor Tr2 when the organic EL element 12 is stopped in light emission. Specifically, the base voltage Vofs is set such that with threshold voltage of the driver transistor Tr2 denoted as Vth, Vofs−Vth has a value (certain value) lower than a value of voltage Vthel+Vcat as the sum of threshold voltage Vthel and cathode voltage Vcat of the organic EL element 12.

The power line driver circuit 25 sequentially applies a power control pulse to a plurality of power lines DSL in accordance with (in synchronization with) the control signal 22A to perform emission on/off control on each organic EL element 12. Specifically, the power line driver circuit 25 selectively outputs voltage Vcc, which is applied when current Ids is flowed through the driver transistor Tr2, and voltage Vss, which is applied when the current Ids is not flowed through the driver transistor Tr2, and thus generates the power control pulse. The voltage Vss is set to have a value (certain value) lower than the value of the voltage Vthel+Vcat as the sum of the threshold voltage Vthel and the cathode voltage Vcat of the organic EL element 12. The voltage Vcc is set to have a value (certain value) equal to or higher than the voltage value Vthel+Vcat.

Operation and Effects of Display Device

Next, operation and effects of the display device 1 of the first embodiment are described.

1. Summary of Display Operation

In the display device 1, as shown in FIGS. 1 and 2, the driver circuit 20 performs display drive of each pixel 11 (11R, 11G and 11B) in the display panel 10 (pixel array section 13) based on the video signal 20A and the synchronizing signal 20B. In the display drive, drive current is injected into an organic EL element 12 in each pixel 11, causing recombination of holes and electrons for light emission. Such emitted light is multiply reflected between an anode (not shown) and a cathode (not shown) of the organic EL element 12, and extracted to the outside through the cathode and the like. As a result, the display panel 10 displays images based on the video signal 20A.

2. Details of Display Operation

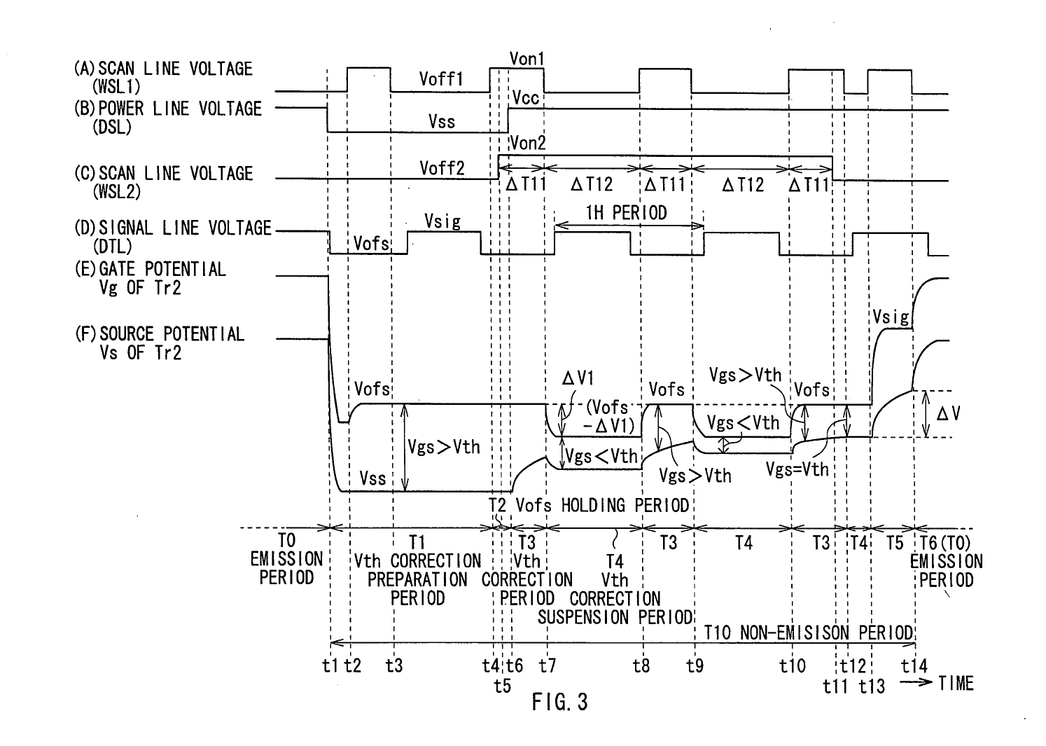

FIG. 3 is a timing chart showing an example of various kinds of waveforms in display operation of the embodiment of the display device 1 (in display drive performed by the driver circuit 20). (A) to (D) of FIG. 3 show voltage waveforms of a scan line WSL1, a power line DSL, a scan line WSL2 and a signal line DTL, respectively. Specifically, they show an aspect where voltage of the scan line WSL1 is periodically changed between the voltages Voff1 and Von1 ((A) of FIG. 3), an aspect where voltage of the power line DSL is periodically changed between the voltages Vcc and Vss ((B) of FIG. 3), an aspect where voltage of the scan line WSL2 is periodically changed between the voltages Voff2 and Von2 ((C) of FIG. 3), and an aspect where voltage of the signal line DTL is periodically changed between the base voltage Vofs and the video signal voltage Vsig ((D) of FIG. 3). (E) and (F) of FIG. 3 show waveforms of gate potential Vg and source potential Vs of the driver transistor Tr2, respectively.

Emission Period T0: Before t1

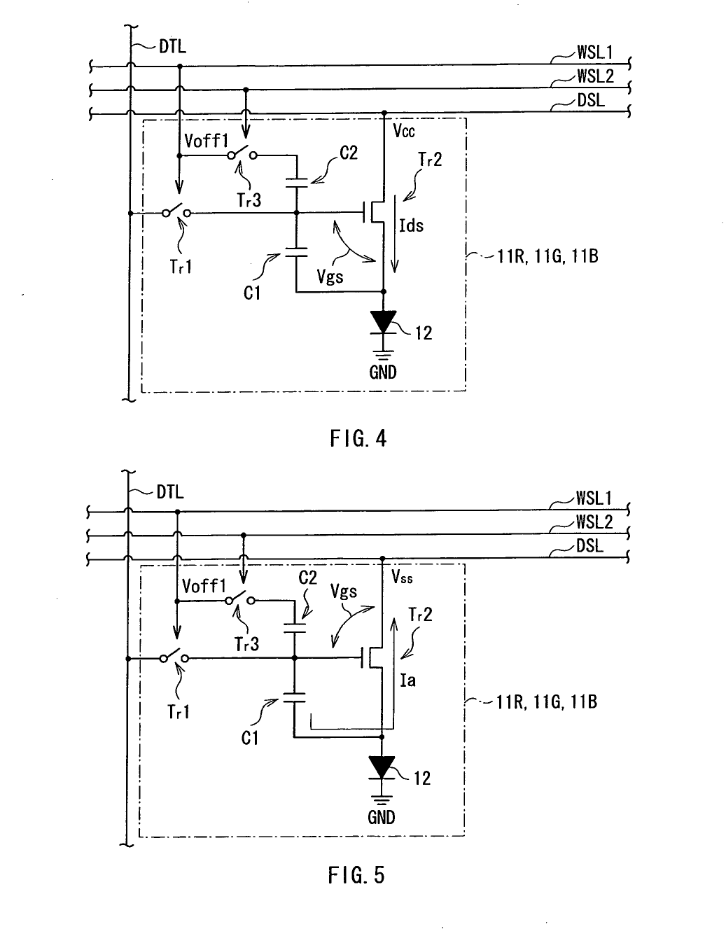

First, in an emission period T0 of the organic EL element 12, voltages of the scan line WSL1, the scan line WSL2, the power line DSL, and the signal line DTL are the voltage Voff1, the voltage Voff2, the voltage Vcc, and the video signal voltage Vsig, respectively ((A) to (D) of FIG. 3). Therefore, as shown in FIG. 4, the write transistor Tr1 and the threshold-correction auxiliary transistor Tr3 are set to be off, respectively. Since the driver transistor Tr2 is set to operate in a saturation region, current Ids flowing through the driver transistor Tr2 and the organic EL element 12 may be expressed by following equation (1). In the equation (1), μ, W, L, Cox, Vgs and Vth denote mobility, channel width, channel length, capacity of gate oxide film per unit area, gate-to-source voltage (see FIG. 4) and threshold voltage of the driver transistor Tr2, respectively.

Ids=(½)×μ×(W/L)×Cox×(Vgs−Vth)² (1)

Vth Correction Preparation Period T1: t1 to t4

Next, the driver circuit 20 finishes the emission period T0 at timing t1, and prepares correction (Vth correction) of the threshold voltage Vth of the driver transistor Tr2 in each pixel 11. Specifically, first, the power line driver circuit 25 lowers voltage of the power line DSL from the voltage Vcc to the voltage Vss at timing t1 ((B) of FIG. 3). Thus, source potential Vs of the driver transistor Tr2 gradually lowers, and finally reaches the voltage Vss corresponding to voltage of the power line DSL ((F) of FIG. 3). Gate potential Vg of the driver transistor Tr2 also lowers through capacitive coupling via the holding capacitive element C1 in accordance with such lowering of the source potential Vs (see (E) of FIG. 3 and current Ia in FIG. 5). Therefore, a value of anode voltage (voltage Vss) of the organic EL element 12 becomes smaller than a value of voltage Vthel+Vcat as the sum of values of threshold voltage Vthel and cathode voltage Vcat of the organic EL element 12, and consequently current Ids does not flow between the anode and the cathode. As a result, the organic EL element 12 does not emit light after the timing t1 (transfer to non-emission period T10 mentioned below). A period from timing t1 to timing t14, at which emission operation described later is started, is the non-emission period T10 where the organic EL element 12 does not emit light.

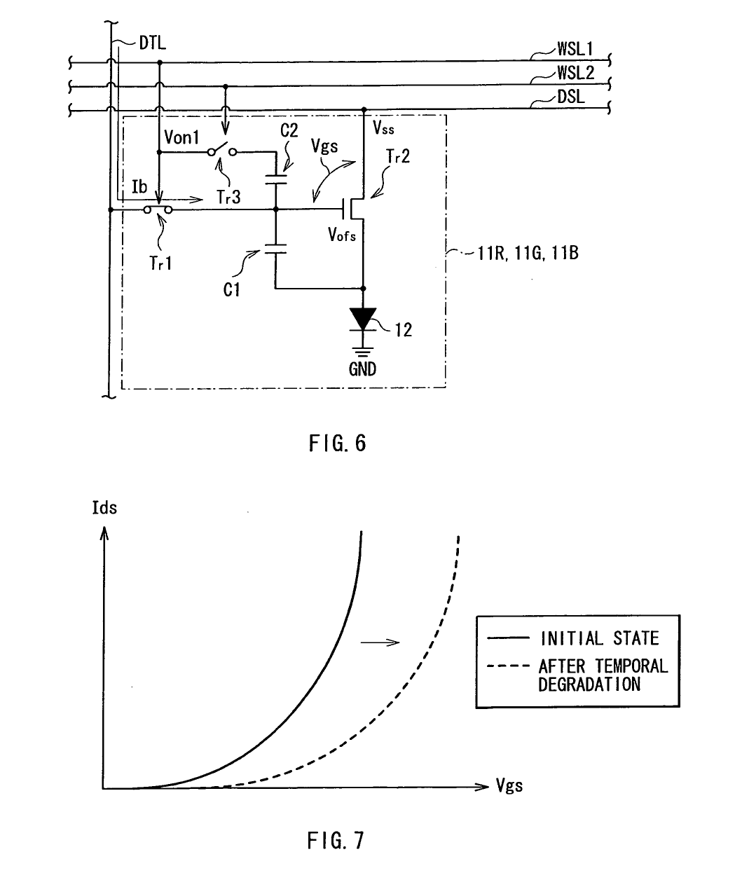

Next, after a predetermined interval (in a period of timing t1 to timing t2), the signal line driver circuit 24 lowers voltage of the signal line DTL from the video signal voltage Vsig to the base voltage Vofs ((D) of FIG. 3). In a period of timing t2 to timing t3, where voltage of the signal line DTL is the base voltage Vofs and voltage of the power line DSL is Vss, the scan line driver circuit 23 sets voltage of the scan line WSL1 to be raised from the voltage Voff1 to the voltage Von1 ((A) of FIG. 3). This causes the write transistor Tr1 to be on and thus current Ib flows as shown in FIG. 6, thereby gate potential Vg of the driver transistor Tr2 eventually reaches the base voltage Vofs corresponding to voltage of the power line DSL in this stage ((E) of FIG. 3). In the stage, gate-to-source voltage Vgs (=Vofs−Vss) of the driver transistor Tr2 becomes higher than the threshold voltage Vth of the transistor Tr2 (Vgs>Vth) as shown in FIG. 3, thereby preparation of Vth correction described later is completed.

Vofs Holding Period T2: t4 to t6

Next, at timing t4 in a period where voltage of the signal line DTL is the base voltage Vofs and voltage of the power line DSL is the voltage Vss, the scan line driver circuit 23 newly sets the voltage of the scan line WSL1 to be raised from the voltage Voff1 to the voltage Von1 ((A) of FIG. 3). In addition, the scan line driver circuit 23 sets voltage of the scan line WSL2 to be raised from the voltage Voff2 to the voltage Von2 at subsequent timing t5 ((C) of FIG. 3).

First Vth Correction Period T3: t6 to t7

Next, the driver circuit 20 performs first Vth correction of the driver transistor Tr2. The Vth correction is performed to reduce or avoid variation in luminance of the organic EL element 12 even if the threshold voltage Vth of the driver transistor Tr2 varies between pixels 11 due to temporal degradation in I-V characteristic or the like, for example, as shown in FIG. 7.

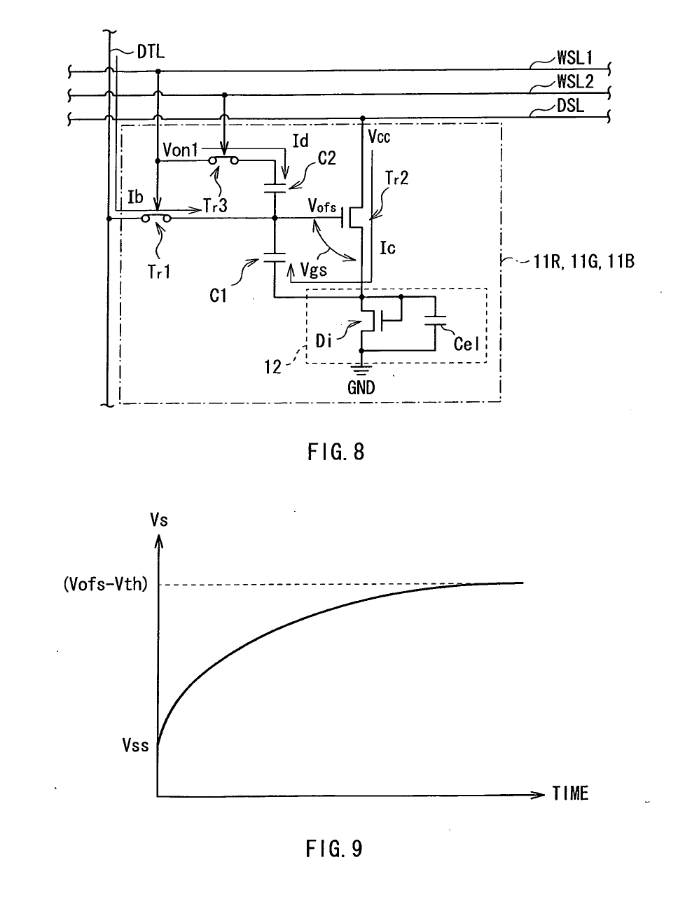

Specifically, first, at timing t6 in a period where voltage of the signal line DTL is the base voltage Vofs and voltages of the scan lines WSL1 and WSL2 are voltages Von1 and Von2 respectively, the power line driver circuit 25 raises voltage of the power line DSL from the voltage Vss to the voltage Vcc ((B) of FIG. 3). Thus, as shown in FIG. 8, current Ic flows between the drain and the source of the driver transistor Tr2, so that source potential Vs rises (see (F) of FIG. 3 and FIG. 9). As shown in FIG. 8, an equivalent circuit of the organic EL element 12 may be expressed by a parallel circuit including a diode component Di and a capacitive component Ce1.

When source potential Vs of the driver transistor Tr2 is lower than a value of voltage Vofs(=Vg)−Vth as shown in FIG. 9 (Vs<(Vg−Vth)), in other words, when gate-to-source voltage Vgs is still higher than the threshold voltage Vth (Vgs>Vth: Vth correction is not completed yet), the holding capacitive element C1 is charged with the current Ic as shown in FIG. 8 such that voltage across the holding capacitive element C1 is equal to the threshold voltage Vth. In other words, current Ic flows between the drain and the source of the driver transistor Tr2 until the transistor Tr2 is cut off (until Vgs=Vth is established), so that the source potential Vs rises ((F) of FIG. 3). However, Vth correction is suspended before Vgs=Vth is established (before Vs=(Vofs−Vth) is established) as described later.

In the first Vth correction period T3, since voltage of the scan line WSL2 is Von2, the threshold-correction auxiliary transistor Tr3 is on as shown in FIG. 8. This leads to flow of current Id to the other end of the threshold-correction auxiliary capacitive element C2 via the threshold-correction auxiliary transistor Tr3. As a result, voltage Von1 corresponding to voltage of the scan line WSL1 in this stage is applied to the other end of the threshold-correction auxiliary capacitive element C2 to charge the capacitive element C2 (first on-period ΔT11 shown in (C) of FIG. 3). In the first on period ΔT11, as shown in FIG. 8, the base voltage Vofs corresponding to voltage of the signal line DTL in this stage is applied to one end of the threshold-correction auxiliary capacitive element C2 for charging and applied to the gate of the driver transistor Tr2.

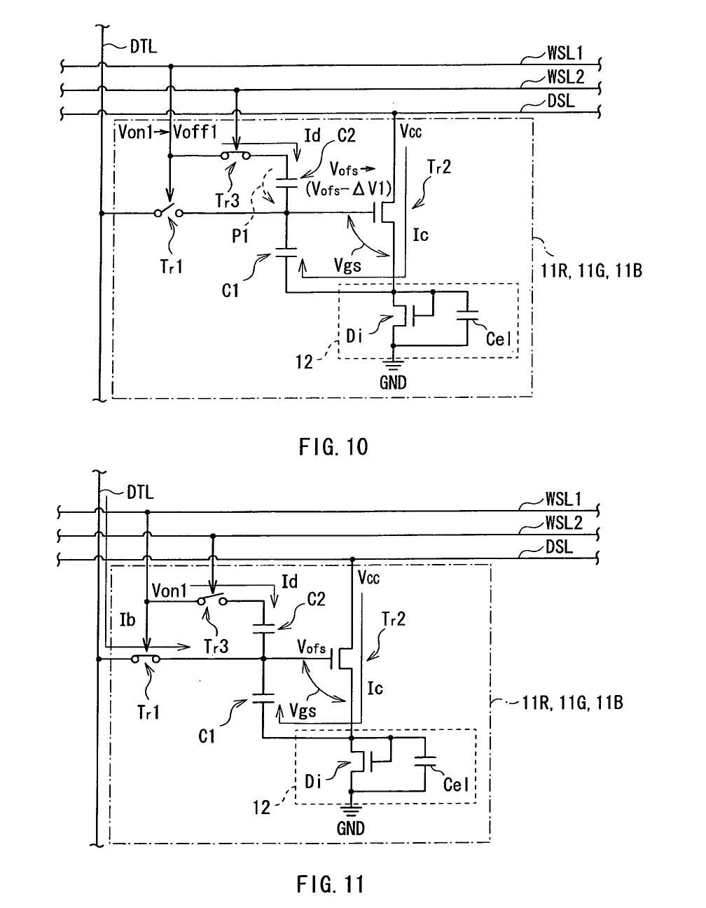

After that, at timing t7 in a period where voltages of the signal line DTL, the power line DSL and the scan line WSL2 are kept as the base voltage Vofs, the voltage Vcc and the voltage Von2 respectively, the scan line driver circuit 23 lowers the voltage of the scan line WSL1 from the voltage Von1 to the voltage Voff1 ((A) of FIG. 3). This causes the write transistor Tr1 to be off as shown in FIG. 10, and therefore the gate of the driver transistor Tr2 turns into floating, and Vth correction is thus suspended (shift to the following first Vth correction suspension period T4).

First Vth Correction Suspension Period T4: t7 to t8

In the Vth correction suspension period T4, while the write transistor Tr1 is off as above, the threshold-correction auxiliary transistor Tr3 is still on as shown in FIG. 10. In addition, voltage of the scan line WSL1 decreasingly changes from the voltage Von1 to the voltage Voff1 at the timing t7 as described above. As shown by an arrow P1, this causes a variation in the scan line WSL1 from the voltage Von1 to the voltage Voff1 to be transmitted to the gate of the driver transistor Tr2 (second on-period ΔT12 shown in (C) of FIG. 3). Specifically, such variation is transmitted to the gate of the driver transistor Tr2 through capacitive coupling (negative coupling) via the threshold-correction auxiliary transistor Tr3 and the threshold correction auxiliary capacitive element C2. Therefore, gate potential of the driver transistor Tr2 lowers from the base voltage Vofs to Vofs−ΔV1, namely, lowers by potential difference Δ V1 (gate potential correction operation).

Thus, gate-to-source voltage Vgs of the driver transistor Tr2 is reduced, and preferably Vgs<Vth is established as shown in FIG. 3. However, as long as the gate-to-source voltage Vgs of the driver transistor Tr2 is reduced to a certain degree, the gate potential of the driver transistor Tr2 need not lower until Vgs<Vth is established. In this way, the gate-to-source voltage Vgs is reduced, as a result, current hardly flows from the power line DSL to the driver transistor Tr2, and therefore the source potential Vs and the gate potential Vg of the driver transistor Tr2 hardly change in the Vth correction suspension period T4.

Second Vth Correction Period T3: t8 to t9

Next, the driver circuit 20 performs Vth correction for the driver transistor Tr2 again (second Vth correction). Specifically, first, at timing t8 in a period where voltage of the signal line DTL is the base voltage Vofs and voltage of the power line DSL is the voltage Vcc, the scan line driver circuit 23 raises voltage of the scan line WSL1 from the voltage Voff1 to the voltage Von1 ((A) of FIG. 3). This causes the write transistor Tr1 to be on again as shown in FIG. 11, and therefore the gate potential Vg of the driver transistor Tr2 newly becomes equal to the base voltage Vofs corresponding to voltage of the signal line DTL in this stage ((E) of FIG. 3). Vgs>Vth is thus established again in the second Vth correction period T3 as shown in FIG. 3, and normal Vth correction operation is performed again.

Even in the second Vth correction period T3, since voltage of the scan line WSL2 is kept as the voltage Von2, the threshold-correction auxiliary transistor Tr3 also remains to be on, and the current Id thus flows as shown in FIG. 11.

In the period, since current Ic flows between the drain and the source of the driver transistor Tr2 as in the first Vth correction period T3, the source potential Vs rises again ((F) of FIG. 3). However, in the period, Vth correction is suspended again before Vgs=Vth is established in the following way. That is, after that, at timing t9 in a period where voltages of the signal line DTL, the power line DSL and the scan line WSL2 are kept as the base voltage Vofs, the voltage Vcc and the voltage Von2 respectively, the scan line driver circuit 23 lowers voltage of the scan line WSL1 from the voltage Von1 to the voltage Voff1 ((A) of FIG. 3). This causes the write transistor Tr1 to be off, and therefore the gate of the driver transistor Tr2 turns into floating, and Vth correction is thus suspended again (shift to the following second Vth correction suspension period T4).

Second Vth Correction Suspension Period T4: t9 to t10

Next, Vth correction is suspended again in a period from timing t9 to timing t10 described later as described before. Specifically, in the second Vth correction suspension period T4, while the write transistor Tr1 is off as above, the threshold-correction auxiliary transistor Tr3 is still on. This leads to gate potential correction operation in the same way as in the first Vth correction suspension period T4, so that gate potential of the driver transistor Tr2 lowers from the base voltage Vofs (second on-period ΔT12). Therefore, even in the second Vth correction suspension period T4, source potential Vs and gate potential Vg of the driver transistor Tr2 hardly change. In the period, Vgs<Vth is established as in the first Vth correction suspension period T4.

Third Vth Correction Period T3 and Third Vth Correction Suspension Period T4: t10 to t13

Next, the driver circuit 20 performs Vth correction for the driver transistor Tr2 again (third Vth correction). Specifically, first, at timing t10 in a period where voltage of the signal line DTL is the base voltage Vofs and voltage of the power line DSL is the voltage Vcc, the scan line driver circuit 23 raises voltage of the scan line WSL1 from the voltage Voff1 to the voltage Von1 ((A) of FIG. 3). This causes the write transistor Tr1 to be on again, and therefore the gate potential Vg of the driver transistor Tr2 newly becomes equal to the base voltage Vofs corresponding to voltage of the signal line DTL in this stage ((E) of FIG. 3). This causes Vgs>Vth to be newly established as in the second Vth correction period T3, and normal Vth correction operation is thus performed again.

Then, current Ic flows between the drain and the source of the driver transistor Tr2 until the transistor Tr2 is cut off (until Vgs=Vth is established), so that the source potential Vs rises as in the previous Vth correction periods T3 ((F) of FIG. 3). It is assumed that Vgs=Vth is established and Vth correction is thus completed at the end of the third Vth correction period T3 (timing t12) as shown in FIG. 3. In other words, the holding capacitive element C1 is charged such that voltage across the capacitive element C1 reaches the threshold voltage Vth, as a result, gate-to-source voltage Vgs of the driver transistor Tr2 becomes equal to the threshold voltage Vth.

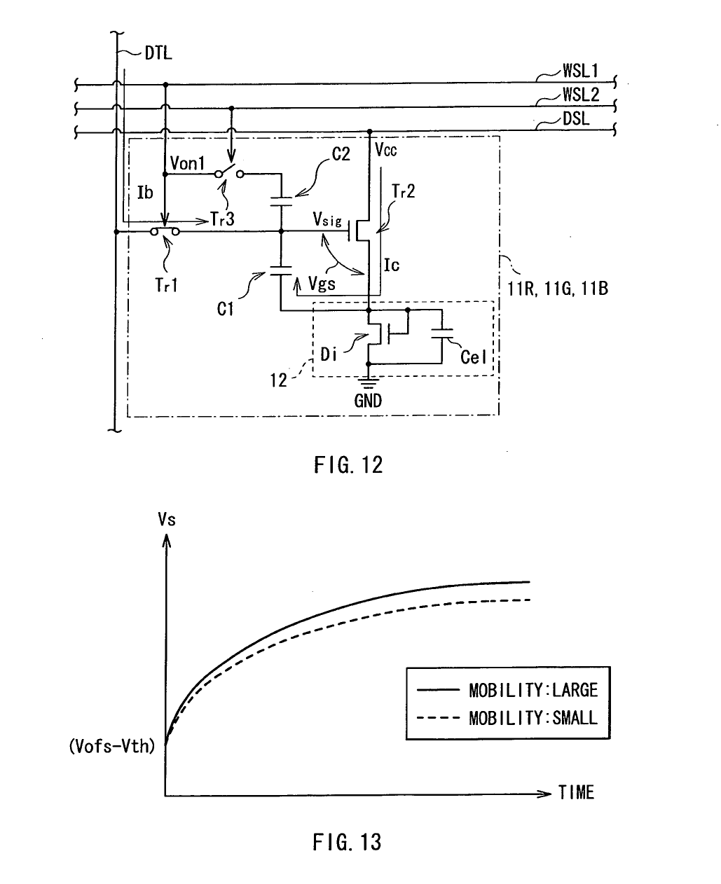

The scan line driver circuit 23 lowers voltage of the scan line WSL2 from the voltage Von2 to the voltage Voff2 at timing t11 in the period ((C) of FIG. 3). This causes the threshold-correction auxiliary transistor Tr3 to be off as shown in FIG. 12.

After that, at timing t12 in a period where voltages of the power line DSL, the scan line WSL2 and the signal line DTL are kept as the voltage Vcc, the voltage Voff2 and the base voltage Vofs respectively, the scan line driver circuit 23 lowers voltage of the scan line WSL1 from the voltage Von1 to the voltage Voff1 ((A) of FIG. 3). This causes the write transistor Tr1 to be off, and therefore the gate of the driver transistor Tr2 turns into floating, as a result, the gate-to-source voltage Vgs is kept as the threshold voltage Vth regardless of magnitude of voltage of the signal line DTL thereafter. Since the threshold-correction auxiliary transistor Tr3 becomes off prior to the write transistor Tr1 as described above, the variation in the scan line WSL1 is not transmitted to the gate of the driver transistor Tr2.

After that, in a period where voltages of the scan lines WSL1 and WSL2 are the voltages Voff1 and Voff2 respectively, and voltage of the power line DSL is the voltage Vcc (period of timing t12 to timing t13), the signal line driver circuit 24 raises voltage of the signal line DTL from the base voltage Vofs to the video signal voltage Vsig ((D) of FIG. 3). The period from timing t12 to timing t13 described later is a third Vth correction suspension period T4.

In this way, a plurality of (here, three) Vth correction periods T3 and a plurality of (here, three) Vth correction suspension periods T4 are repeatedly provided respectively so that the gate-to-source voltage Vgs is set to the threshold voltage Vth (Vth correction is performed), thereby the following advantage is obtained. That is, even if the threshold voltage Vth of the driver transistor Tr2 varies between pixels 11 (11R, 11G and 11B), variation in luminance of the organic EL element 12 may be avoided.

Mobility Correction/Signal Writing Period T5: t13 to t14

Next, the driver circuit 20 performs correction of mobility μ (mobility correction) for the driver transistor Tr2 while performing writing of the video signal voltage Vsig (writing of a video signal) in the following way. Specifically, first, at timing t13 in a period where voltage of the signal line DTL is the video signal voltage Vsig, and voltage of the power line DSL is the voltage Vcc, the scan line driver circuit 23 raises voltage of the scan line WSL1 from the voltage Voff1 to the voltage Von1 ((A) of FIG. 3). This causes the write transistor Tr1 to be on as shown in FIG. 12, and therefore the gate potential Vg of the driver transistor Tr2 rises due to current Ib from the base voltage Vofs to the video signal voltage Vsig corresponding to voltage of the signal line DTL in this stage ((E) of FIG. 3).

In this stage, a value of anode voltage of the organic EL element 12 is still smaller than a value of voltage Vthel+Vcat as the sum of the threshold voltage Vthel and the cathode voltage Vcat of the organic EL element 12, and therefore organic EL element 12 is cut off. In other words, in this stage, current does not flow between the anode and the cathode of the organic EL element 12 yet (the organic EL element 12 does not emit light). Therefore, current Ic supplied from the driver transistor Tr2 flows to the capacitive component Ce1, which exists in parallel between the anode and the cathode of the organic EL element 12, so that the capacitive component Ce1 is charged. As a result, the source potential Vs of the driver transistor Tr2 rises by potential difference ΔV ((F) of FIG. 3), so that the gate-to-source voltage Vgs becomes equal to Vsig+Vth−ΔV.

When mobility μ of the driver transistor Tr2 is large, increase in source potential Vs (potential difference ΔV) is also large, for example, as shown in FIG. 13. Therefore, the gate-to-source voltage Vgs is reduced by (fed back with) the potential difference ΔV as described above before light emission described later, and thereby variation in mobility μ between pixels 11 may be eliminated.

Emission Period T6 (T0): after t14

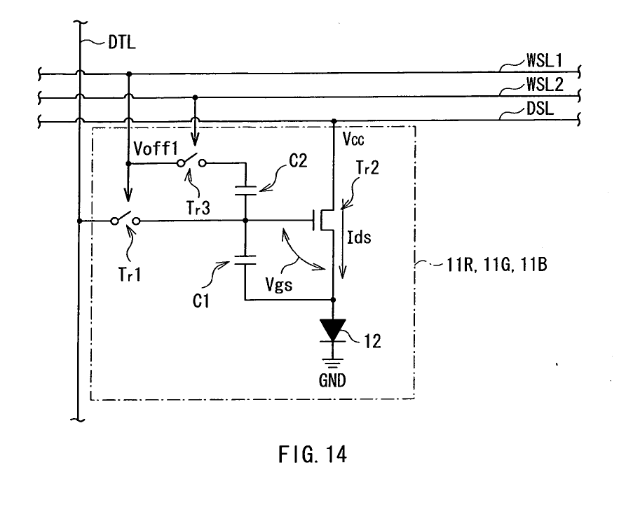

Next, at timing t14 in a period where voltages of the signal line DTL, the power line DSL and the scan line WSL2 are kept as the video signal voltage Vsig, the voltage Vcc and the voltage Voff2 respectively, the scan line driver circuit 23 lowers voltage of the scan line WSL1 from the voltage Von1 to the voltage Voff1 ((A) of FIG. 3). This causes the write transistor Tr1 to be off as shown in FIG. 14, and therefore the gate of the driver transistor Tr2 turns into floating. Thus, current Ids flows between the drain and the source of the driver transistor Tr2 while the gate-to-source voltage Vgs of the transistor Tr2 is kept constant. As a result, the source potential Vs of the driver transistor Tr2 rises ((F) of FIG. 3), and accordingly the gate potential Vg of the transistor Tr2 rises through capacitive coupling via the holding capacitive element C1 ((E) of FIG. 3).

This causes a value of the anode voltage of the organic EL element 12 to be larger than a value of the voltage Vthel+Vcat as the sum of the threshold voltage Vthel and the cathode voltage Vcat of the organic EL element 12. In other words, the source potential Vs of the driver transistor Tr2 rises to a predetermined voltage ((F) of FIG. 3). Accordingly, current Ids flows between the anode and the cathode of the organic EL element 12, so that the organic EL element emits light with desired luminance (emission period T6 (T0)).

Repetition

After that, the driver circuit 20 performs display drive such that the periods T1 to T6 (T0) are periodically repeated every one frame period. In addition, the driver circuit 20 causes each of the power control pulse applied to the power line DSL, the selection pulse applied to the scan line WSL1 and the switching control pulse applied to the scan line WSL2 to scan in a row direction. As hereinbefore, display operation of the display device 1 (display drive by the driver circuit 20) is performed.

3. Gate Potential Correction Operation (Auxiliary Operation of Vth Correction)

Next, as one of features in display operation of the display device 1 of the embodiment, correction operation of the gate potential Vg of the driver transistor Tr2 with the scan line WSL2, performed by the scan line driver circuit 23, is described in detail in comparison with comparative examples (comparative examples 1 and 2).

Pixel Circuit Configuration of Comparative Examples

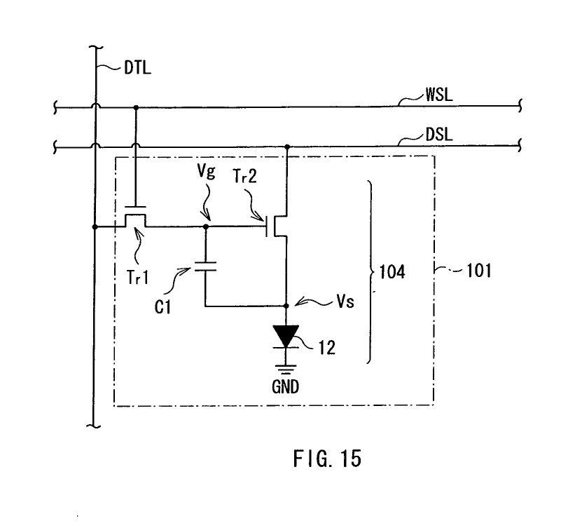

First, a pixel circuit configuration common to the following comparative examples 1 and 2 (and comparative examples 3 and 4) is described with reference to FIG. 15. FIG. 15 shows an internal configuration of a pixel 101 in the past according to the comparative examples. In the pixel 101, a pixel circuit 104 including the organic EL element 12 is provided.

The pixel circuit 104 according to the comparative examples includes the organic EL element 12, the write transistor Tr1, the driver transistor Tr2 and the holding capacitive element C1, namely, has a circuit configuration of so-called 2Tr1C. In other words, the pixel circuit 104 corresponds to a circuit configuration where the threshold-correction auxiliary transistor Tr3 and the threshold-correction auxiliary capacitive element C2 are not provided in (omitted from) the pixel circuit 14 of the embodiment shown in FIG. 2. In addition, the two kinds of scan lines WSL1 and WSL2 are accordingly not provided unlike in the embodiment, and only one scan line WSL (corresponding to the scan line WSL1 of the embodiment) is provided.

### Comparative Example 1

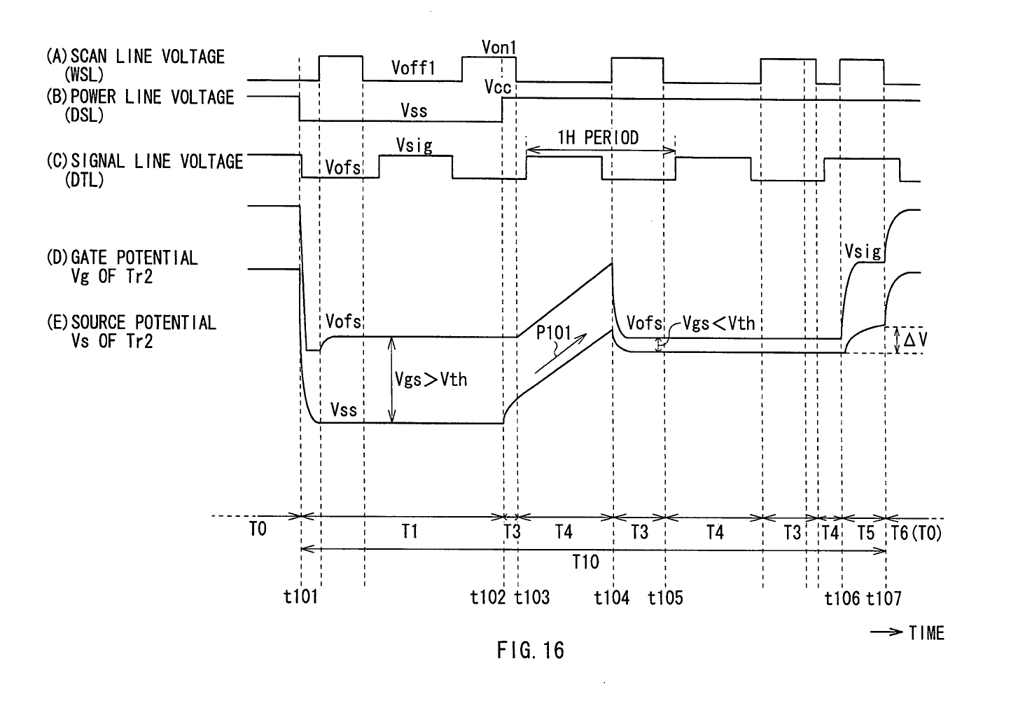

FIG. 16 is a timing chart showing an example of various kinds of waveforms in display operation of the display device of the comparative example 1 (timing t101 to timing t107). (A) to (C) of FIG. 16 show voltage waveforms of the scan line WSL, a power line DSL, and a signal line DTL, respectively. Specifically, the voltage waveforms show an aspect where voltage of the scan line WSL is periodically changed between voltages Voff and Von ((A) of FIG. 16), an aspect where voltage of the power line DSL is periodically changed between voltages Vcc and Vss ((B) of FIG. 16), and an aspect where voltage of the signal line DTL is periodically changed between base voltage Vofs and video signal voltage Vsig ((C) of FIG. 16). (D) and (E) of FIG. 16 show gate potential Vg and source potential Vs of the driver transistor Tr2, respectively.

In display operation of the comparative example 1, Vth correction operation is performed several times (here, three times) in a segmented manner as in the embodiment shown in FIG. 3 (segmented Vth correction operation). In other words, respective three Vth correction periods T3 and respective three Vth correction suspension periods T4 are continuously provided. In this case, as described before, when Vth correction operation has not been completed (finished), gate-to-source voltage Vgs of the driver transistor Tr2 is higher than threshold voltage Vth of the transistor (Vgs>Vth, see FIG. 16).

When a Vth correction period T3 is short (for example, a period of timing t102 to timing t103), or a Vth correction suspension period T4 is long (for example, a period of timing t103 to timing t104) as in the comparative example 1, the following difficulty may occur. That is, as shown by a sign P101 in FIG. 16, increase in source potential Vs of the driver transistor Tr2 may become excessively large in the Vth correction suspension period T4.

After that, when the Vth correction operation is performed again, the gate-to-source voltage Vgs of the driver transistor Tr2 is lower than the threshold voltage Vth (Vgs<Vth), and therefore Vth correction operation is not normally performed thereafter (for example, a period of timing t104 to timing t106). As a result, Vth correction operation is finished before being completed, namely, is insufficiently performed, and consequently variation in luminance remains between pixels 11. Particularly, when high-speed display drive is performed, length of 1 H period is reduced, and time of Vth correction is accordingly reduced, and therefore such a difficulty particularly occurs.

### Comparative Example 2

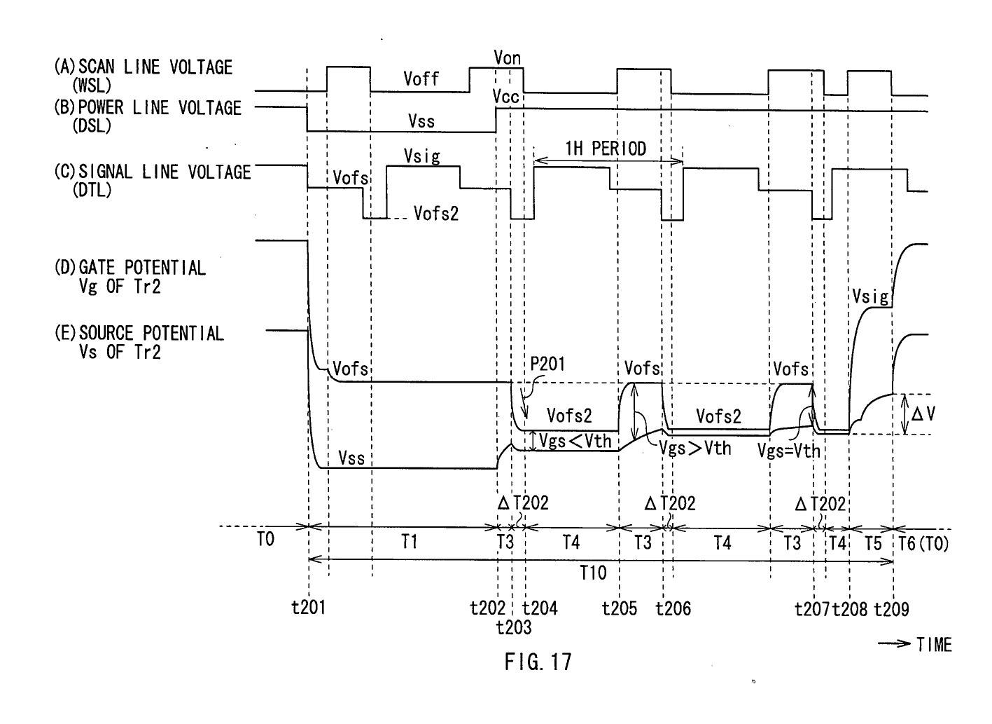

In display operation of the comparative example 2 as shown in (A) to (E) of FIG. 17 (timing t201 to timing t209), the difficulty of the comparative example 1 may be overcome in the following way. Specifically, in the comparative example 2, first, voltage applied to the signal line DTL is set to voltage Vofs2, being lower than predetermined base voltage Vofs, at the end of each Vth correction operation T3 (before start of each Vth correction suspension operation T4) (period ΔT202). This leads to lowering of gate potential Vg of the driver transistor Tr2 from the base voltage Vofs to the low voltage Vofs2 (see an arrow P201 in FIG. 17). Therefore, gate-to-source voltage Vgs of the driver transistor Tr2 becomes lower than the threshold voltage Vth of the transistor (Vgs<Vth) in a subsequent Vth correction suspension period T4. In a subsequent Vth correction period T3, the gate potential Vg of the driver transistor Tr2 is newly set to the base voltage Vofs. Consequently, the comparative example 2 may avoid the difficulty of the comparative example 1, or excessive increase in source potential Vs of the driver transistor Tr2 in. the Vth correction suspension period T4, allowing normal Vth correction operation to be performed again.

However, in the comparative example 2, three-valued voltage needs to be applied to the signal line DTL (three-valued voltage including the video signal voltage Vsig, the base voltage Vofs and the low voltage Vofs2 needs to be used), leading to increase in withstanding voltage of the driver circuit (particularly, signal line driver circuit). Generally, when withstanding voltage of the driver circuit (driver) increases, manufacturing cost accordingly increases, and therefore the method of the comparative example 2 hardly provides reduction in cost.

### The Embodiment

In the display device 1 of the embodiment, as shown in FIG. 3 and the like, the scan line driver circuit 23 performs the following gate potential correction operation (auxiliary operation of Vth correction), and thereby may overcome either of the difficulties of the comparative examples 1 and 2.

Specifically, in an on-period where the switching control pulse is applied to the scan line WSL2 so that the threshold-correction auxiliary transistor Tr3 is set to be on (first on-period ΔT11 and second on-period ΔT12 in FIG. 3), the scan line driver circuit 23 performs the following operation. That is, the variation in the scan line WSL1 from the voltage Von1 to the voltage Voff1 is transmitted to the gate of the driver transistor Tr2 via the threshold-correction auxiliary transistor Tr3 and the threshold-correction auxiliary capacitive element C2, thereby gate potential correction operation to lower the gate potential Vg of the driver transistor Tr2 is performed.

More specifically, first, the scan line driver circuit 23 provides the first on-period ΔT11 for applying the base voltage Vofs to one end of the threshold-correction auxiliary capacitive element C2 and to the gate of the driver transistor Tr2, and applying the voltage Von1 to the other end of the capacitive element C2. Moreover, the circuit 23 provides after the first on-period ΔT11 the second on-period ΔT12 for applying the voltage Voff1 to the other end of the threshold-correction auxiliary capacitive element C2 so that the variation from the voltage Von1 to the voltage Voff1 is transmitted to the gate of the driver transistor Tr2. The first on-periods ΔT11 and the second on-periods ΔT12 are provided by at least one (here, three) periods respectively for the gate potential correction operation.

Such a first on-period ΔT11 is provided in correspondence to at least, first one period among a plurality of Vth correction periods T3 (here, provided in correspondence to each of the three Vth correction periods T3). The second on-period ΔT12 is provided between the first on-period ΔT11 and a next Vth correction period T3. The respective first on-periods ΔT11 and the respective second on-periods ΔT12 are continuously provided.

In this way, in the on period ΔT11 or ΔT12, the variation in the scan line WSL1 from the voltage Von1 to the voltage Voff1 is transmitted to the gate of the driver transistor Tr2 via the threshold-correction auxiliary transistor Tr3 and the threshold-correction auxiliary capacitive element C2. This leads to gate potential correction operation to lower the gate potential Vg of the driver transistor Tr2. Therefore, the gate-to-source voltage Vgs of the driver transistor Tr2 is reduced, and therefore the difficulty of the comparative example 1 is avoided in Vth correction operation. In other words, insufficient Vth correction operation of the driver transistor Tr2, which is caused by excessive increase in source potential Vs, is avoided, namely, sufficient (normal) Vth correction operation is performed. Moreover, since such gate potential correction operation is achieved by using the variation in the scan line WSL1 from the voltage Von1 to the voltage Voff1 (variation between two voltages), three-valued voltage need not be used unlike in the comparative example 2.

As hereinbefore, in the embodiment, since the gate potential correction operation to lower the gate potential Vg of the driver transistor Tr2 is performed, insufficient Vth correction operation of the driver transistor Tr2 caused by excessive increase in source potential Vs, which may occur in the comparative example 1, may be avoided without using three-valued voltage unlike in the comparative example 2. Accordingly, variation in luminance between pixels 11 may be suppressed without increasing withstanding voltage of the driver circuit 20 (particularly, signal line driver circuit 24), and consequently reduction in cost and improvement in image quality may be achieved together.

Moreover, even if the Vth correction period T3 is set short, variation in luminance between pixels 11 may be suppressed unlike in the comparative example 1, and therefore high-speed display drive operation may be achieved. Therefore, the embodiment may meet the case that the number of horizontal lines (number of the pixels 11) in the display panel 10 is increased, and therefore increase in screen size of the display panel 10 or increase in definition of the pixels 11 may be achieved.

While the embodiment has been described with a case where the respective first on-periods ΔT11 and the respective second on-periods ΔT12 are continuously provided as shown in FIG. 3, the first and second on-periods may be discontinuously provided.

Next, other embodiments (second and third embodiments) of the invention are described. The same components as in the first embodiment are marked with the same reference numerals or signs, and description of them is appropriately omitted.

### Second Embodiment

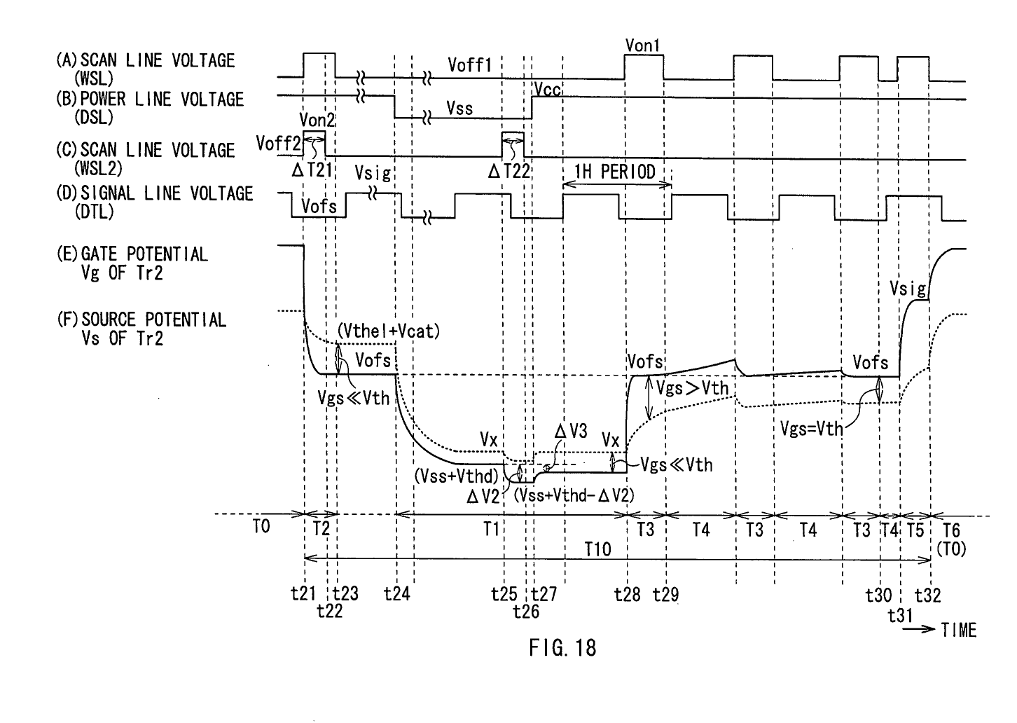

FIG. 18 is a timing chart showing an example of various kinds of waveforms in display operation according to a second embodiment (timing t21 to timing t32). The kinds of voltage waveforms shown in (A) to (F) of FIG. 18 are the same as those shown in (A) to (F) of FIG. 3 in the first embodiment. Hereinafter, display operation of the embodiment is described in detail with reference to FIG. 18 and FIGS. 19 to 23.

A block configuration of a display device 1 and a configuration of a pixel circuit 14 in a pixel 11 are the same as in the first embodiment, and therefore description of them is omitted. In addition, since basic portions in display operation are the same as those shown in FIG. 3 and the like in the first embodiment, description of the portions is appropriately omitted.

1. Detail of Display Operation

Vofs Holding Period T2: t21 to t23

First, at timing t21 in a period where voltage of the signal line DTL is base voltage Vofs and voltage of the power line DSL is voltage Vcc, the scan line driver circuit 23 sets voltage of the scan line WSL1 to be raised from voltage Voff1 to voltage Von1 ((A) of FIG. 18). In addition, the scan line driver circuit 23 sets voltage of the scan line WSL2 to be raised from voltage Voff2 to voltage Von2 at the timing t21 ((C) of FIG. 18).

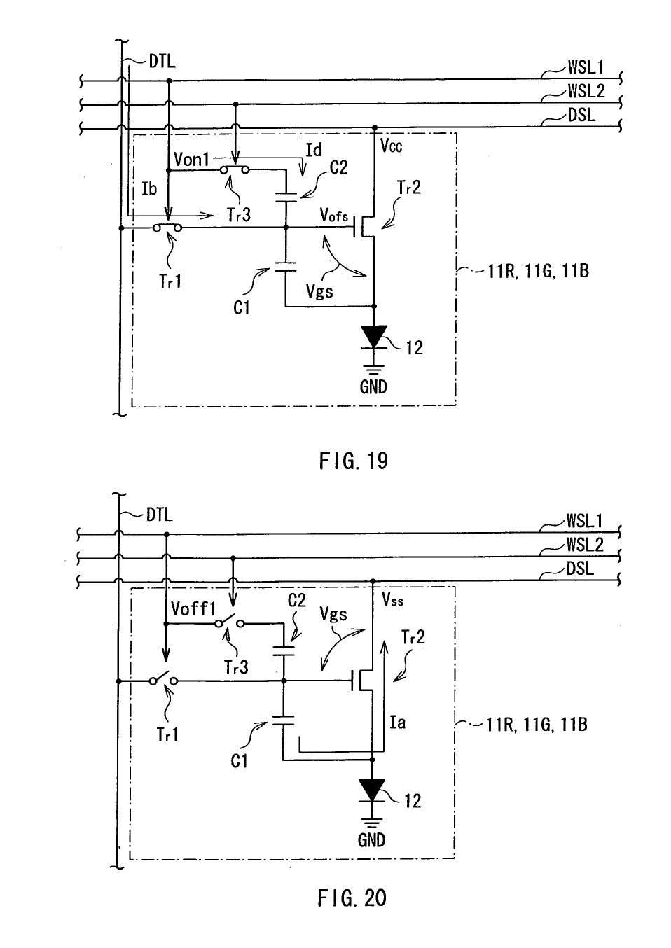

As shown in FIG. 18, this causes gate-to-source voltage Vgs of the driver transistor Tr2 to be lower than threshold voltage Vth (Vgs<Vth). As a result, current Ids does not flow through the organic EL element 12 as shown in FIG. 19, and therefore the element 12 stops light emission (a non-emission period T10 is given after the timing t21).

In a period of the timing t21 to the timing t22, each of the write transistor Tr1 and the threshold-correction auxiliary transistor Tr3 is on. This causes voltage Von1, which is corresponding to voltage of the scan line WSL1 in this stage, to be applied to the other end of the threshold-correction auxiliary capacitive element C2 to charge the capacitive element C2 (first on-period ΔT21 shown in (C) of FIG. 18). In the first on period ΔT21, as shown in FIG. 19, the base voltage Vofs corresponding to voltage of the signal line DTL in this stage is applied to one end of the threshold-correction auxiliary capacitive element C2 for charging and to the gate of the driver transistor Tr2.

After that, the scan line driver circuit 23 lowers the voltage of the scan line WSL2 from the voltage Von2 to the voltage Voff2 at timing t22 ((C) of FIG. 18), and lowers the voltage of the scan line WSL1 from the voltage Von1 to the voltage Voff1 ((A) of FIG. 18) at timing t23. This causes each of the write transistor Tr1 and the threshold-correction auxiliary transistor Tr3 to be off.

In a subsequent period of timing t23 to timing t24, voltage applied between an anode and a cathode of the organic EL element 12 is equal to threshold voltage Vthel of the element 12. Therefore, anode voltage of the organic EL element 12 (source potential Vs of the driver transistor Tr2) is equal to the sum of the threshold voltage Vthel and cathode voltage Vcat of the element 12, or Vthel+Vcat.

Vth Correction Preparation Period T1: t24 to t28

Next, the driver circuit 20 prepares Vth correction for the driver transistor Tr2 in each pixel 11. Specifically, first, the power line driver circuit 25 lowers voltage of the power line DSL from voltage Vcc to voltage Vss at timing t24 ((B) of FIG. 18). Thus, source potential Vs of the driver transistor Tr2 lowers with time ((F) of FIG. 18). Gate potential Vg of the driver transistor Tr2 also lowers through capacitive coupling via the holding capacitive element C1 in accordance with such lowering of the source potential Vs (see (E) of FIG. 18 and current Ia in FIG. 20). In other words, gate-to-source voltage Vgs of the driver transistor Tr2 is reduced with time as shown in FIG. 18.

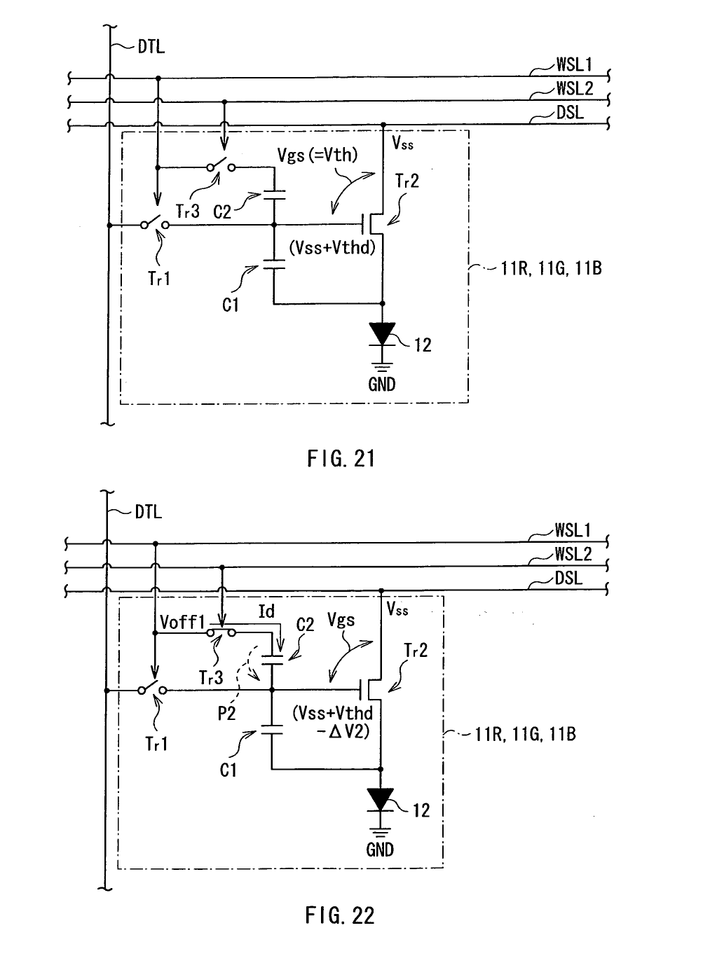

In the case that the driver transistor Tr2 operates in a saturation region, namely, in the case of (Vgs−Vthd)≦Vds, the gate potential Vg of the driver transistor Tr2 reaches Vss+Vthd at timing t25 when a certain time has passed as shown in FIG. 21. Vthd denotes a threshold voltage between a gate of the driver transistor Tr2 and a power source, and Vds denotes a voltage between a source and a drain of the driver transistor Tr2.

Next, at timing t25 in a period where voltage of the scan line WSL1 is the voltage Voff1 and voltage of the power line DSL is the voltage Vss, the scan line driver circuit 23 raises voltage of the scan line WSL2 from the voltage Voff2 to the voltage Von2 ((C) of FIG. 18). This causes the threshold-correction auxiliary transistor Tr3 to be on while the write transistor Tr1 is off as shown in FIG. 22. Thus, as shown by an arrow P2 in FIG. 22, the variation in the scan line WSL1 (the other end of the threshold-correction auxiliary capacitive element C2) from the voltage Von1 to the voltage Von2 is transmitted to the gate of the driver transistor Tr2 (second on-period ΔT22 shown in (C) of FIG. 18). Specifically, such variation is transmitted to the gate of the driver transistor Tr2 through capacitive coupling (negative coupling) via the threshold-correction auxiliary transistor Tr3 and the threshold-correction auxiliary capacitive element C2. Therefore, gate potential of the driver transistor Tr2 lowers from Vss+Vthd to Vss+Vthd−ΔV2, namely, lowers by potential difference ΔV2 (gate potential correction operation).

Thus, the gate-to-source voltage Vgs of the driver transistor Tr2 is reduced preferably until Vgs<<Vth is established as shown in FIG. 18. In this way, the gate-to-source voltage Vgs is reduced, as a result, current hardly flows from the power line DSL to the driver transistor Tr2, and therefore the source potential Vs and the gate potential Vg of the driver transistor Tr2 hardly change in a subsequent period to timing t26.

Next, the scan line driver circuit 23 lowers voltage of the scan line WSL2 from the voltage Von2 to the voltage Voff2 so that the threshold-correction auxiliary transistor Tr3 is set to be off at the timing t26. In addition, the power line driver circuit 25 raises voltage of the power line DSL from the voltage Vss to the voltage Vcc at subsequent timing t27.

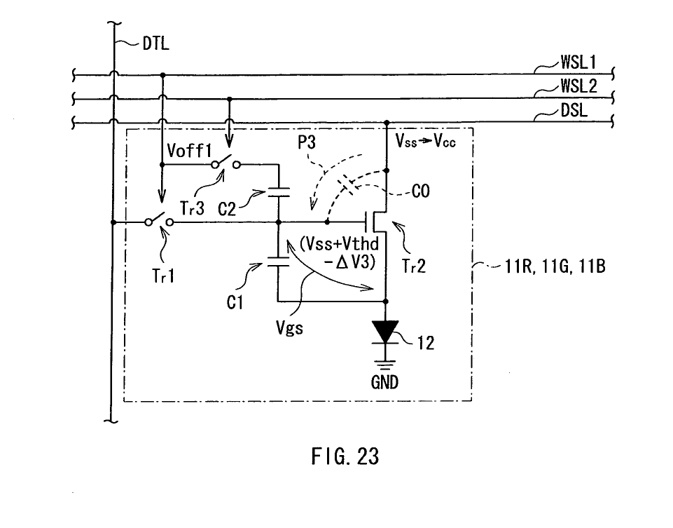

This causes the variation in the power line DSL from the voltage Vss to the voltage Vcc to be transmitted to the gate of the driver transistor Tr2 as shown by an arrow P3 in FIG. 23. Specifically, the variation is transmitted to the gate of the driver transistor Tr2 through capacitive coupling (positive coupling) via a coupling capacitive component C0 as shown. Therefore, gate potential of the driver transistor Tr2 rises from Vss+Vthd−ΔV2. Such increase in potential is beforehand set to be smaller than the potential difference ΔV2, thereby the gate potential Vg lowers from Vss+Vthd to Vss+Vthd−ΔV3 by potential difference ΔV3 through capacitive coupling as a total of negative and positive capacitive coupling as shown in FIG. 18.

Anode potential of the organic EL element 12 in this stage is indicated as Vx as shown in FIG. 18. Voltage of the power line DSL is changed to the voltage Vcc and thus the source of the driver transistor Tr2 becomes equivalent to the anode of the organic EL element 12, and therefore the gate-to-source voltage Vgs of the driver transistor Tr2 is reduced by capacitive coupling through the threshold-correction auxiliary capacitive element C2. Specifically, Vgs<<Vth is established here. This causes only off current to flow through the driver transistor Tr2, and therefore the gate potential Vg and the source potential Vs of the driver transistor Tr2 hardly increase until subsequent timing t28 (until first Vth correction period T3 is started).

In this way, Vgs>Vth is established again in the subsequent first Vth correction period T3 as shown in FIG. 18 as in the first embodiment, and normal Vth correction operation is thus performed.

Subsequent Period: t29 to t32

After that, a mobility correction/signal writing period T5 and an emission period T6 (T0) are provided after a plurality of Vth correction periods T3 and a plurality of Vth correction suspension periods T4 as in the first embodiment. Consequently, emission operation is performed.

2. Gate Potential Correction Operation

Next, gate potential correction operation of the embodiment (auxiliary operation of Vth correction) is described in detail in comparison with comparative examples (comparative examples 3 and 4). Since a configuration of a pixel circuit in each of the comparative examples 3 and 4 is the same as the pixel circuit 104 (circuit of 2Tr1C, see FIG. 15) in the comparative examples 1 and 2, description of the pixel circuit is omitted.

### Comparative Example 3

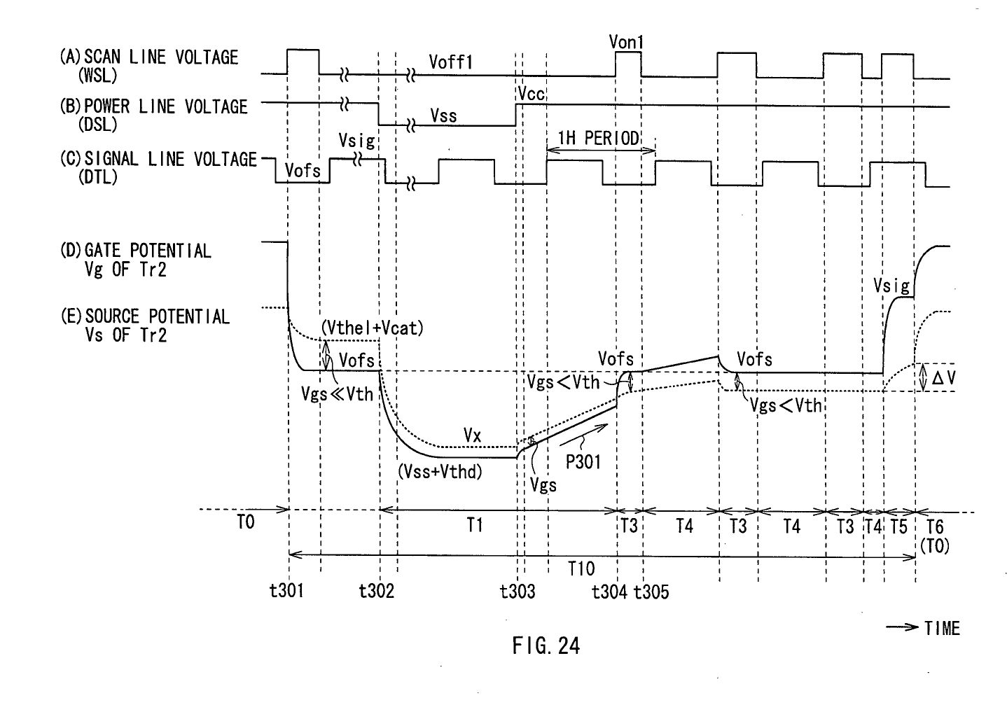

FIG. 24 is a timing chart showing an example of various kinds of waveforms in display operation of a display device of the comparative example 3 (timing t301 to timing t305). The kinds of the voltage waveforms shown in (A) to (E) of FIG. 24 are the same as shown in (A) to (E) of FIG. 16 in the comparative example 1.

In display operation of the comparative example 3, the gate-to-source voltage Vgs of the driver transistor Tr2 is high in a period of timing t303 to timing t304 within the Vth correction preparation period T1 compared with in a period of the timing t25 to the timing t28 in the embodiment described before. Therefore, leakage current from a power line DSL applied with the voltage Vcc is considerably large, so that the source potential Vs of the driver transistor Tr2 may excessively increase as shown by an arrow P301 in FIG. 24.

After that, when Vth correction operation is performed, the gate-to-source voltage Vgs of the driver transistor Tr2 may be lower than the threshold voltage Vth (Vgs<Vth), and therefore Vth correction operation may not be normally performed thereafter (for example, a period of timing t304 to timing t305). As a result, Vth correction operation is finished before being completed, namely, is insufficiently performed as in the comparative example 1, and consequently variation in luminance remains between pixels 11.

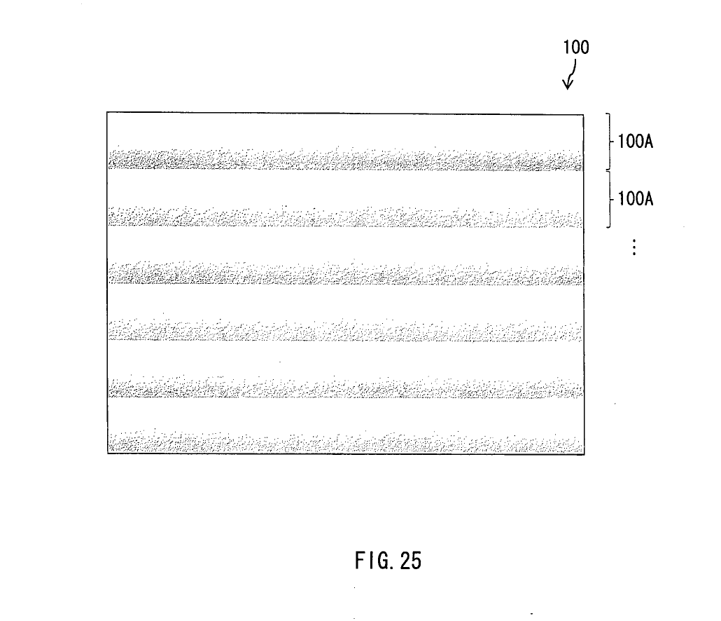

Moreover, in the comparative example 3,since the source potential Vs of the driver transistor Tr2 excessively rises in a period before Vth correction operation as described before, for example, when a power line DSL is shared between a plurality of horizontal lines in order to achieve reduction in cost, the following difficulty may occur. That is, when the power line DSL is shared in such a way, since length of a period before Vth correction operation is different for each of the horizontal lines, increase in source potential Vs is also different for each of the horizontal lines. Therefore, the amount of Vth correction is also different for each of the horizontal lines, resulting in variation in luminance for each of the horizontal lines within a power-line-shared horizontal-line region 100A, for example, as a display panel 100 shown in FIG. 25. In other words, a stripe pattern, where luminance gradually changes along a vertical line direction, occurs within the power-line-shared horizontal-line region 100A.

### Comparative Example 4

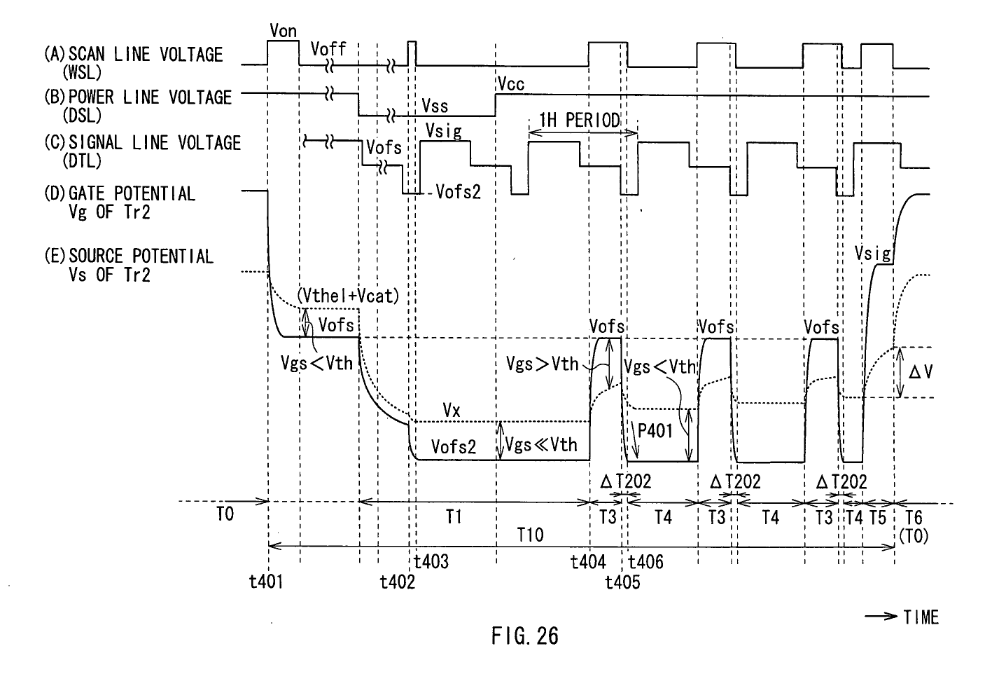

In display operation in the comparative example 4 as shown in FIG. 26 (timing t401 to timing t406), the difficulty of the comparative example 3 may be overcome in the same way as in the comparative example 2. Specifically, in the comparative example 4, voltage of the scan line WSL1 is raised from the voltage Voff1 to the voltage Von1 in a period of timing t402 to timing t403 within a Vth correction preparation period T1. This leads to lowering of the gate potential Vg of the driver transistor Tr2 from the predetermined base voltage Vofs to the voltage Vofs2 lower than the base voltage Vofs. Therefore, the gate-to-source voltage Vgs of the driver transistor Tr2 becomes lower than the threshold voltage Vth of the transistor Tr2 (Vgs<<Vth) in a period of timing t403 to timing t404. The gate potential Vg of the driver transistor Tr2 is newly set to the base voltage Vofs in a subsequent Vth correction period T3. Consequently, the comparative example 4 may avoid the difficulty of the comparative example 3, or excessive increase in source potential Vs of the driver transistor Tr2 caused by leakage current from the power line DSL applied with the voltage Vcc in the Vth correction preparation period T1, allowing normal Vth correction operation to be performed.

However, even in the comparative example 4,three-valued voltage needs to be applied to the signal line DTL (three-valued voltage including the video signal voltage Vsig, the base voltage Vofs and the low voltage Vofs2 needs to be used) as in the comparative example 2. Therefore, manufacturing cost is increased in accordance with increase in withstanding voltage of the driver circuit (particularly, signal line driver circuit), and consequently reduction in cost is still hard to be achieved.

### The Embodiment

In the embodiment, as shown in FIG. 18 and the like, the scan line driver circuit 23 performs the following gate potential correction operation as in the first embodiment, thereby either of the difficulties of the comparative examples 3 and 4 may be overcome.

Specifically, in an on-period where the switching control pulse is applied to the scan line WSL2 so that the threshold-correction auxiliary transistor Tr3 is set to be on (the first on-period ΔT21 and the second on-period ΔT22 in FIG. 18), the scan line driver circuit 23 performs the following operation. That is, the variation in the scan line WSL1 (the other end of the threshold-correction auxiliary capacitive element C2) from the voltage Von1 to the voltage Voff1 is transmitted to the gate of the driver transistor Tr2 via the threshold-correction auxiliary transistor Tr3 and the threshold-correction auxiliary capacitive element C2. This leads to gate potential correction operation to lower the gate potential Vg of the driver transistor Tr2.

More specifically, first, the scan line driver circuit 23 provides the first on-period ΔT21 for applying the base voltage Vofs to one end of the threshold-correction auxiliary capacitive element C2 and to the gate of the driver transistor Tr2, and applying the voltage Von1 to the other end of the capacitive element C2. In addition, the circuit 23 provides, after the first on-period ΔT21, the second on-period ΔT22 for applying the voltage Voff1 to the other end of the threshold-correction auxiliary capacitive element C2 so that the variation from the voltage Von1 to the voltage Voff1 is transmitted to the gate of the driver transistor Tr2. Each of the first and second on-periods ΔT21 and ΔT22 is singly provided for the gate potential correction operation.

Each of the first and second on-periods ΔT21 and ΔT22 is provided within a period before each of at least one (here, three) Vth correction periods T3 is started. The first and second on-periods ΔT21 and ΔT22 are provided with a predetermined interval in between (provided in a discontinuous manner).

In this way, in the on period ΔT21 or ΔT22, the variation of the scan line WSL1 from the voltage Von1 to the voltage Voff1 is transmitted to the gate of the driver transistor Tr2 via the threshold-correction auxiliary transistor Tr3 and the threshold-correction auxiliary capacitive element C2. This leads to gate potential correction operation to lower the gate potential Vg of the driver transistor Tr2. Therefore, the gate-to-source voltage Vgs of the driver transistor Tr2 is reduced, and therefore the difficulty of the comparative example 3 is avoided in Vth correction operation. In other words, insufficient Vth correction operation of the driver transistor Tr2, which is caused by excessive increase in source potential Vs due to leakage current, is avoided, namely, sufficient (normal) Vth correction operation is performed. Moreover, since such gate potential correction operation is achieved by using the variation in the scan line WSL1 from the voltage Von1 to the voltage Voff1 (variation between two voltages), three-valued voltage need not be used unlike in the comparative example 4.

As hereinbefore, even in the embodiment, the same advantage may be obtained through the same operation as in the first embodiment. In other words, variation in luminance between pixels 11 may be suppressed without increasing withstanding voltage of the driver circuit 20 (particularly, signal line driver circuit 24), and consequently reduction in cost and improvement in image quality may be achieved together.

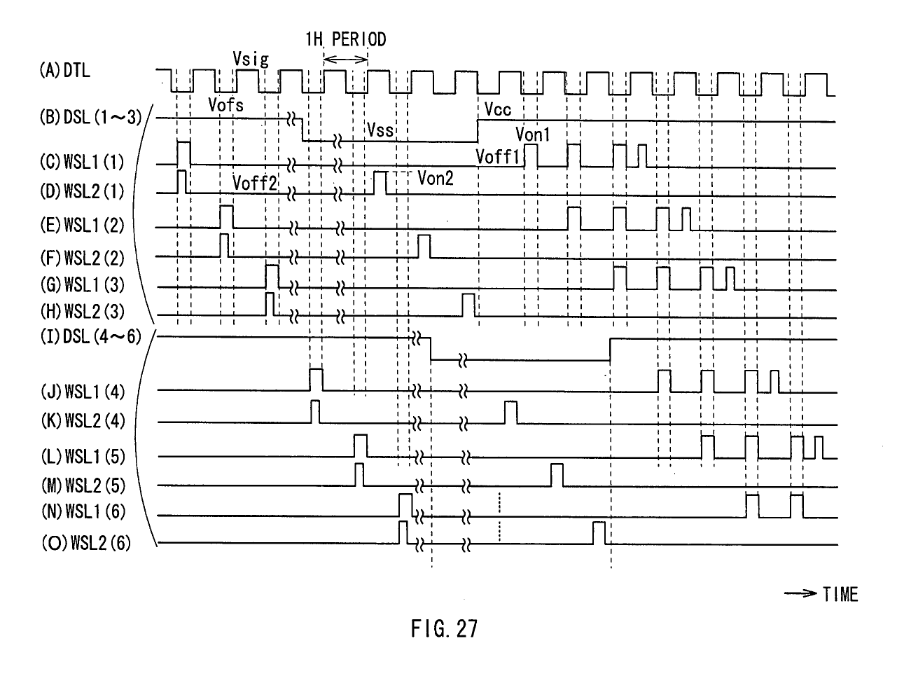

Particularly, in the embodiment, unlike in the comparative example 3, even if a power line DSL is shared between pixels 11 on a plurality of horizontal lines, variation in luminance between the horizontal lines as shown in FIG. 25 may be substantially eliminated. Specifically, when it is assumed that a power line DSL is shared between a plurality of (here, three) horizontal lines, for example, as shown in (A) to (O) of FIG. 27, the following can be true. Here, a power line DSL (1 to 3) and a power line DSL (4 to 6) show a power line shared between first to third horizontal lines and a power line shared between fourth to sixth horizontal lines, respectively. In addition, scan lines WSL1 (1) to WSL1 (6) and scan lines WSL2 (1) to WSL2 (6) show scan lines WSL1 along first to sixth horizontal lines and scan lines WSL2 along first to sixth horizontal lines respectively. In this case, while length of a period before Vth correction operation is different for each of the horizontal lines, since increase in source potential Vs is originally negligibly small in each horizontal line, difference in amount of Vth correction between the horizontal lines is also negligible. Therefore, even if a power line DSL is shared between pixels 11 on a plurality of horizontal lines, variation in luminance between the horizontal lines may be substantially eliminated. Accordingly, the embodiment has a further advantage of decrease in number of power lines DSL in addition to the above advantage, enabling further reduction in cost and further improvement in yield.

### Third Embodiment

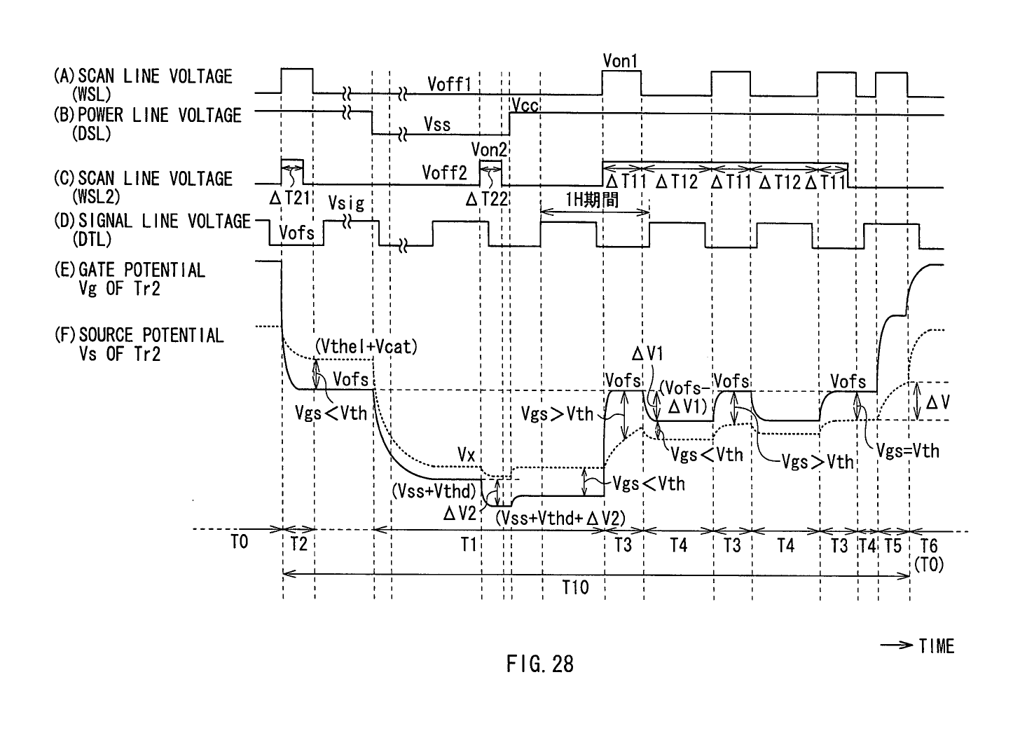

FIG. 28 is a timing chart showing an example of various kinds of waveforms in display operation according to a third embodiment. The kinds of voltage waveforms shown in (A) to (F) of FIG. 28 are the same as those shown in (A) to (F) of FIG. 3 in the first embodiment. A block configuration of a display device 1 and a configuration of a pixel circuit 14 in a pixel 11 are the same as in the first embodiment, and therefore description of them is omitted. In addition, the same portions in display operation as in the first or second embodiment are appropriately omitted to be described.

The embodiment corresponds to an embodiment with a combination of the gate potential correction operation in the first embodiment and the gate potential correction operation in second embodiment. In other words, in the embodiment, both the first on-periods ΔT11 and ΔT21 and both the second on-periods ΔT12 and ΔT22 are provided.

Accordingly, even in the embodiment, the same advantage may be obtained through the same operation as in the first and second embodiments. In other words, variation in luminance between pixels 11 may be suppressed without increasing withstanding voltage of the driver circuit 20 (particularly, signal line driver circuit 24), and consequently reduction in cost and improvement in image quality may be achieved together.

Moreover, in the embodiment, since the gate potential correction operation in the first embodiment is combined with the gate potential correction operation in the second embodiment, insufficient Vth correction operation due to excessive increase in source potential Vs may be effectively suppressed compared with in each of the above embodiments, and consequently further improvement in image quality may be achieved.

### Module and Application Examples

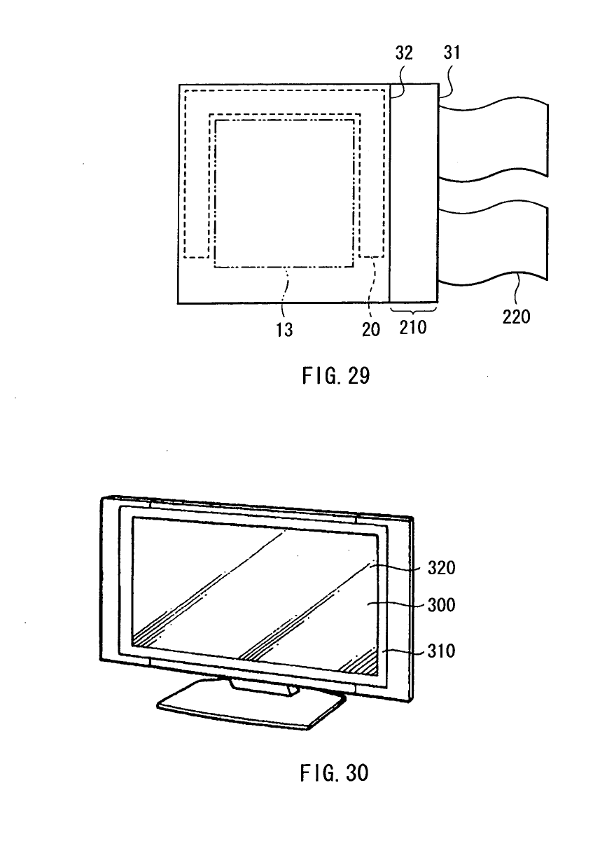

Hereinafter, application examples of the display device described in the first to third embodiments are described with reference to FIG. 29 to FIG. 34. The display device of each of the embodiments may be used for electronic units in any field, including a television apparatus, a digital camera, a notebook personal computer, a mobile terminal such as mobile phone, and a video camera. In other words, the display device may be used for electronic units in any field for displaying still or video images based on an externally-input or internally-generated video signal.

Module

The display device of each of the embodiments may be built in various electronic units such as application examples 1 to 5 described below, for example, in a form of a module shown in FIG. 29. In the module, for example, a region 210 exposed from a sealing substrate 32 is provided in one side of a substrate 31, and external connection terminals (not shown) are formed in the exposed region 210 by extending wiring lines of a driver circuit 20. The external connection terminals may be attached with a flexible printed circuit (FPC) 220 for input or output of signals.

### Application Example 1

FIG. 30 shows appearance of a television apparatus using the display device of each of the embodiments. The television apparatus has, for example, an image display screen 300 including a front panel 310 and filter glass 320, and the image display screen 300 is configured of the display device of each of the embodiments.

### Application Example 2

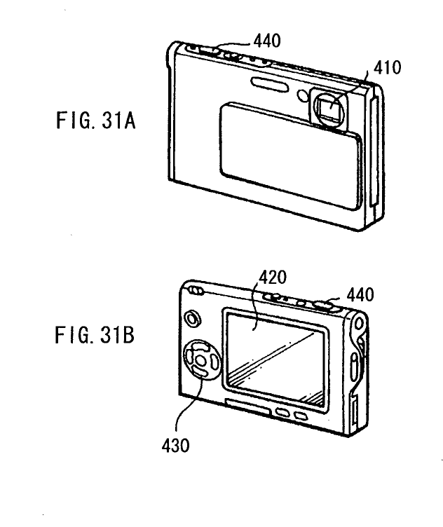

FIGS. 31A and 31B show appearance of a digital camera using the display device of each of the embodiments. The digital camera has, for example, a light emitting section for flash 410, a display 420, a menu switch 430 and a shutter button 440, and the display 420 is configured of the display device of each of the embodiments.

### Application Example 3

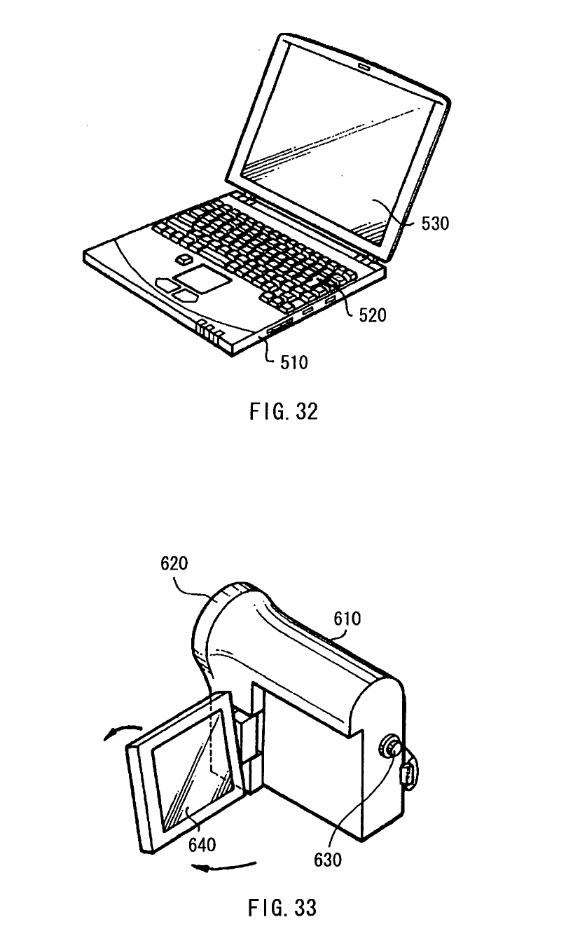

FIG. 32 shows appearance of a notebook personal computer using the display device of each of the embodiments. The notebook personal computer has, for example, a body 510, a keyboard 520 for input operation of letters and the like, and a display 530 for displaying images, and the display 530 is configured of the display device of each of the embodiments.

### Application Example 4

FIG. 33 shows appearance of a video camera using the display device of each of the embodiments. The video camera has, for example, a body 610, an object-shooting lens 620 provided on a front side-face of the body 610, a start/stop switch 630 for shooting, and a display 640. The display 640 is configured of the display device of each of the embodiments.

### Application Example 5

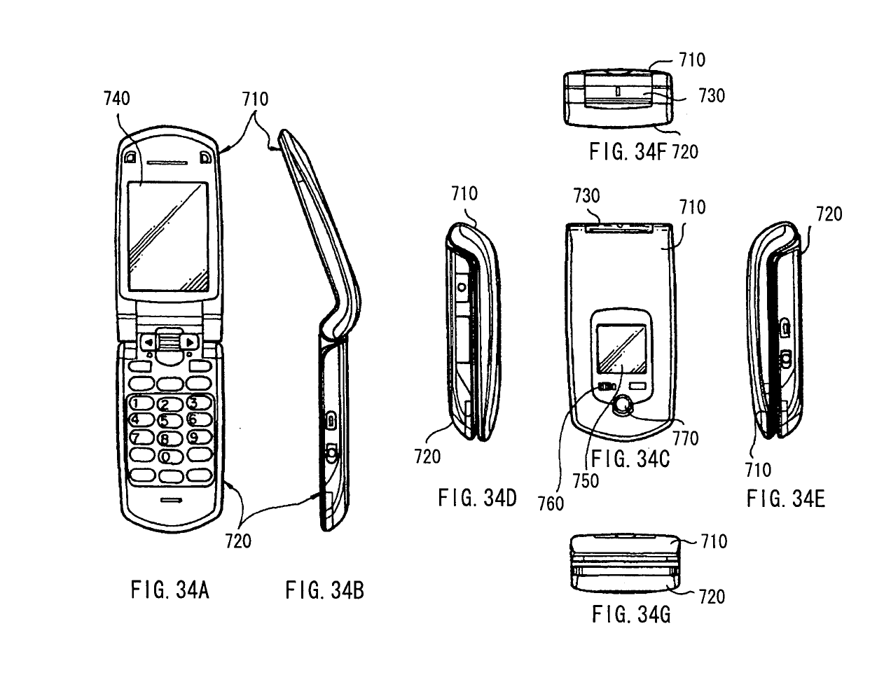

FIGS. 34A to 34G show appearance of a mobile phone using the display device of each of the embodiments. For example, the mobile phone is assembled by connecting an upper housing 710 to a lower housing 720 by a hinge 730, and has a display 740, a sub display 750, a picture light 760, and a camera 770. The display 740 or the sub display 750 is configured of the display device of each of the embodiments.

### Modifications

While the invention has been described with the embodiments and the application examples hereinbefore, the invention is not limited to the embodiments and the like, and various modifications and alterations may be made.

For example, while the embodiments and the like have been described with a case where the display device 1 is an active-matrix display device, a configuration of the pixel circuit 14 for active matrix drive is not limited to those described in the embodiment and the like. For example, the threshold-correction auxiliary transistor Tr3 and the threshold-correction auxiliary capacitive element C2 may be reversed in arrangement order as long as they are connected in series between the gate of the write transistor Tr1 and the gate of the driver transistor Tr2. Even in such a configuration, the same advantage as in the embodiments may be obtained. Moreover, a capacitive element or a transistor may be added to the pixel circuit 14 as necessary. In such a case, a driver circuit to be necessary may be added in addition to the scan line driver circuit 23, the signal line driver circuit 24, and the power line driver circuit 25 in correspondence to change in pixel circuit 14.

Moreover, while the timing generator circuit 22 controls drive operation of each of the scan line driver circuit 23, the signal line driver circuit 24, and the power line driver circuit 25 in the embodiments and the like, another circuit may control drive operation of the circuits. In addition, the scan line driver circuit 23, the signal line driver circuit 24, and the power line driver circuit 25 may be controlled by hardware (circuit) or software (program).

Moreover, while the embodiments and the like have been described with a case where the write transistor Tr₁, the driver transistor Tr₂ and the threshold-correction auxiliary transistor Tr3 are formed of n-channel transistors (for example, n-channel MOS TFT), the case is not limitative. In other words, the transistors may be formed of p-channel transistors (for example, p-channel MOS TFT).

The present application contains subject matter related to that disclosed in Japanese Priority Patent Application JP 2010-039270 filed in the Japan Patent Office on Feb. 24, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a plurality of pixels, each pixel having a pixel circuit including a light emitting element, first to third transistors, a first capacitive element as holding capacitive element, and a second capacitive element;
first and second scan lines, a signal line and a power line, the lines being connected to each pixel;
a scan line driver circuit applying a selection pulse to the first scan line, the selection pulse including a portion of predetermined on-voltage and a portion of predetermined off-voltage to select a group of pixels from the plurality of pixels one after another, the scan line driver circuit further applying a switching control pulse to the second scan line to perform on/off control on the third transistor;
a signal line driver circuit alternately applying a predetermined base voltage and a predetermined video signal voltage to the signal line to write a video signal to a corresponding pixel in the group of pixels selected by the scan line driver circuit; and
a power line driver circuit applying a power control pulse to the power line to perform emission on/off control on the light emitting element,
wherein the pixel circuit is configured in such a manner that,
a gate of the first transistor is connected to the first scan line,
one of a drain and a source of the first transistor is connected to the signal line, and the other is connected to a gate of the second transistor as well as one end of the first capacitive element,
one of a drain and a source of the second transistor is connected to the power line, and the other is connected to the other end of the first capacitive element as well as an anode of the light emitting element,
a cathode of the light emitting element is set to a fixed potential, and
the third transistor and the second capacitive element are connected in series between the gate of the first transistor and the gate of the second transistor, and a gate of the third transistor is connected to the second scan line.

2. The display device according to claim 1, wherein
the scan line driver circuit performs a gate potential correction operation during an on-period in which the third transistor is activated by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor.

3. The display device according to claim 2, wherein
the scan line driver circuit performs the gate potential correction operation through providing at least one first on-period and at least second on-period which follows the first on-period, the first on-period allowing the base voltage to be applied to one end of the second capacitive element as well as the gate of the second transistor and allowing the on voltage to be applied to the other end of the second capacitive element, and the second on-period allowing the variation in the first scan line voltage to be transmitted to the gate of the second transistor through application of the off voltage to the other end of the second capacitive element.

4. The display device according to claim 3, wherein
at least one threshold correction operation for the second transistor in each pixel is performed by the scan line driver circuit, the signal line driver circuit and the power line driver circuit start, and
the sole first on-period and the sole second on-period are provided before the threshold correction operation with a predetermined interval.

5. The display device according to claim 4, wherein the power line is shared by pixels over a plurality of horizontal lines.

6. The display device according to claim 3, wherein
a plurality of segmented threshold correction operations for the second transistor in each pixel are performed by the scan line driver circuit, the signal line driver circuit and the power line driver circuit start, and
the first on-period is provided in correspondence to at least a period of first segmented threshold correction operation, and
the second on-period is provided between the first on-period and a period of a subsequent segmented threshold correction operation.

7. The display device according to claim 6, wherein the first and second on-periods are continuously provided.

8. The display device according to claim 2, wherein the scan line driver circuit performs the gate potential correction operation such that gate-to-source voltage Vgs of the second transistor is lower than threshold voltage Vth of the second transistor.

9. The display device according to claim 1, wherein the light emitting element is an organic electroluminescence element.

10. A method of driving a display device comprising steps of:
connecting a plurality of pixels to first and second scan lines, a signal line and a power line, the plurality of pixels each having a pixel circuit including a light emitting element, first to third transistors, a first capacitive element as holding capacitive element and a second capacitive element;
applying a selection pulse to the first scan line, the selection pulse including a portion of predetermined on-voltage and a portion of predetermined off-voltage to select a group of pixels from the plurality of pixels one after another, while alternately applying a predetermined base voltage and a predetermined video signal voltage to the signal line to write a video signal to a corresponding pixel in the group of pixels selected; and
applying a power control pulse to the power line to perform emission on/off control on the light emitting element, wherein
a gate potential correction operation is performed during an on-period in which the third transistor is set to be on by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor.

11. The method of driving a display device according to claim 10, wherein the pixel circuit is configured in such a manner that,
a gate of the first transistor is connected to the first scan line,
one of a drain and a source of the first transistor is connected to the signal line, and the other is connected to the gate of the second transistor as well as one end of the first capacitive element,
one of a drain and a source of the second transistor is connected to the power line, and the other is connected to the other end of the first capacitive element as well as an anode of the light emitting element,
a cathode of the light emitting element is set to a fixed potential, and
the third transistor and the second capacitive element are connected in series between the gate of the first transistor and the gate of the second transistor, and a gate of the third transistor is connected to the second scan line.

12. An electronic unit having a display device, the display device comprising:
a plurality of pixels, each pixel having a pixel circuit including a light emitting element, first to third transistors, a first capacitive element as holding capacitive element, and a second capacitive element;
first and second scan lines, a signal line and a power line, the lines being connected to each pixel;
a scan line driver circuit applying a selection pulse to the first scan line, the selection pulse including a portion of predetermined on-voltage and a portion of predetermined off-voltage to select a group of pixels from the plurality of pixels one after another, the scan line driver circuit further applying a switching control pulse to the second scan line to perform on/off control on the third transistor;
a signal line driver circuit alternately applying a predetermined base voltage and a predetermined video signal voltage to the signal line to write a video signal to a corresponding pixel in the group of pixels selected by the scan line driver circuit; and
a power line driver circuit applying a power control pulse to the power line to perform emission on/off control on the light emitting element,
wherein the pixel circuit is configured in such a manner that,
a gate of the first transistor is connected to the first scan line,
one of a drain and a source of the first transistor is connected to the signal line, and the other is connected to a gate of the second transistor as well as one end of the first capacitive element,
one of a drain and a source of the second transistor is connected to the power line, and the other is connected to the other end of the first capacitive element as well as an anode of the light emitting element,
a cathode of the light emitting element is set to a fixed potential, and
the third transistor and the second capacitive element are connected in series between the gate of the first transistor and the gate of the second transistor, and a gate of the third transistor is connected to the second scan line.

13. A pixel circuit comprising:
a light emitting element;
first to third transistors;
a first capacitive element as holding capacitive element; and
a second capacitive element, wherein
a gate of the first transistor is connected to a first scan line which is applied with a selection pulse including a portion of a predetermined on-voltage and a portion of a predetermined off-voltage,
one of a drain and a source of the first transistor is connected to a signal line which is alternately applied with a predetermined base voltage and a predetermined video signal voltage, and the other is connected to a gate of the second transistor as well as one end of the first capacitive element,
one of a drain and a source of the second transistor is connected to a power line which is applied with a power control pulse for allowing emission on/off control of the light emitting element, and the other is connected to the other end of the first capacitive element as well as an anode of the light emitting element,
a cathode of the light emitting element is set to a fixed potential, and
the third transistor and the second capacitive element are connected in series between the gate of the first transistor and the gate of the second transistor, and a gate of the third transistor is connected to a second scan line which is applied with a switching control pulse for allowing on/off control of the third transistor.

14. The pixel circuit according to claim 13, wherein
a gate potential correction operation is performed during an on-period in which the third transistor is activated by the switching control pulse applied to the second scan line, the gate potential correction operation allowing a variation in first scan line voltage from the on-voltage to the off-voltage to be transmitted to the gate of the second transistor via the third transistor and the second capacitive element, thereby to lower gate potential of the second transistor.

15. A display device comprising:
a pixel circuit including a light emitting element, first to third transistors, a first capacitive element, and a second capacitive element; and
first and second scan lines, a signal line and a power line,
wherein the pixel circuit is configured in such a manner that,
a gate of the first transistor is connected to the first scan line,
one of a drain and a source of the first transistor is connected to the signal line, and the other is connected to a gate of the second transistor as well as one end of the first capacitive element,
one of a drain and a source of the second transistor is connected to the power line, and the other is connected to the other end of the first capacitive element as well as the light emitting element,
the third transistor and the second capacitive element are connected in series between the gate of the first transistor and the gate of the second transistor, and
a gate of the third transistor is connected to the second scan line.

16. A display device comprising:
a pixel circuit including a light emitting element, first to third transistors, and a capacitive element; and
a scan line,
wherein the pixel circuit is configured in such a manner that,
one of a drain and a source of the first transistor is connected to a gate of the second transistor,
the third transistor and the capacitive element are connected in series between a gate of the first transistor and the gate of the second transistor, and
variation in scan line voltage is transmitted to the gate of the second transistor via the third transistor and the second capacitive element.
